(19) United States
(12) Patent Application Publication
(10) Pub. No.: US 2005/0287925 A1
(43) Pub. Date: Dec. 29, 2005

(54) Collectible item and code for interactive games

(76) Inventors: Nathan Proch, (US); Tim Parsey, (US); Keith Kirby, Hoffman Estates, IL (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/961,678

(22) Filed: Oct. 8, 2004

Related U.S. Application Data
(63) Continuation-in-part of application No. 10/361,157, filed on Feb. 7, 2003.

(51) Int. Cl. A63H 17/26; B44C 1/22

(52) U.S. Cl. 446/470; 216/94

(57) ABSTRACT

Disclosed is a method of manufacturing a toy, comprising of forming a human readable code on a section of the toy by laser etching material from said section.

The present application is a continuation-in-part, and claims the benefit of, U.S. Pat. No. 10/361,157 to Kirby et. al, filed Oct. 22, 2003, the disclosure which is hereby incorporated by reference for all purposes.

### FIELD

The present disclosure relates generally to methods, systems and apparatus for features of an inter-related toy item.

### BACKGROUND AND SUMMARY

The present disclosure relates generally to interactive program and methods of interacting with programs, and more specifically to interactive games and methods that use collectible items, such as tradable items. The tradable items may have a unique code, which is used by a computer program to control access to portions of the computer program.

One such example uses toy cars that are packaged with a separate code covered by a removable coating. Various unique codes are provided that can be used by a user as an access code for an interactive program (which may be a computer game on a CDROM, or on the Internet). There are many unique identifying numbers that unlock a variety of different features in the program or give prizes, and codes may have limited use. In other words, a large variety of codes may be needed, since once a code is used, it may no longer be functional, or have limited functionality. One example of a website is PlanetHotwheels.com. Another example is as described in U.S. Ser. No. 10/361,157.

However, the inventors herein have recognized several issues with the above example. In particular, since the code is separate from the vehicle, it may be lost by the user. Alternatively, it may be traded separately from the car with which it came, and therefore defeat certain features of an associated program. Further, it may require additional packaging to separately obscure the code from view while on display in the store. Further still, manufacturing costs may be increased due to the addition of a separate card or other piece to hold and secure the code (and possibly the removable coating).

To address at least some of the above issues, as well as others, an alternative approach may be used in which the code is located on the collectible item, such as on a toy car. In this way, it may be less likely to be lost, or traded separately from the car, and additional packing requirements may be reduced. However, since a large variety of codes may be needed, (which may be constantly changing, perhaps even different codes on every single car produced), conventional approaches for adding codes to the vehicles may add significant manufacturing costs. For example, it is known to add certain codes, such as model numbers, to collectible items by designing the codes into the manufacturing molds. However, if the code is changed often, costs become prohibitive since a new mold is needed. Further, since a set of collectible items may include items with a variety of materials, such as plastic, metal, etc., a different molding process may be required for each material. This can also add manufacturing cost and complexity. Further still, such an approach may also be susceptible to forgeries.

Therefore, to provide the desired flexibility, the inventors herein have developed an approach that uses laser etching to add codes to collectible items, such as cars. Since the laser can be reprogrammed as often as necessary, changes to the mold are no longer required to change codes on a given product (although new molds may also be used, if desired). Further, more automated manufacturing can be used since computer generated codes can be used and fed to the laser etching machine during the manufacturing process, thereby avoiding slow, time consuming, manual labor to change codes (although manual code changes or reprogramming may be used, if desired). Further still, such an approach may be extremely cost effective, and may be applied to a variety of different materials. It also can produce codes that are more difficult to counterfeit, thereby providing more security in the collection. At the same time, it is possible to affix a code to the vehicle.

### BRIEF DESCRIPTION OF THE DRAWINGS

FIG. 1 shows an example toy vehicle;

FIG. 2 shows an example wheel and shaft assembly;

FIG. 3 shows an example wheel;

FIG. 4 shows an example part of the wheel of FIG. 3;

FIGS. 5A-B show example toy vehicle bodies, chassis, and other components;

FIG. 6A-K shows an alternative example wheel;

FIG. 7A-D shows alternative embodiment example wheels;

FIG. 8 shows an example method of manufacturing wheels;

FIG. 9 shows an example method of manufacturing and painting a plastic item;

FIGS. 10A-D show example packaging for a toy vehicle and card(s);

FIG. 11 shows various example cards and related aspects for a card game, as well as instructions;

FIG. 12 shows an alternative card that may be include in the package of FIG. 10;

FIGS. 13 and 13B show example carrier items;

FIGS. 14A and 14B shows a front section of a carrier vehicle with a first example device for collecting and/or dispersing items;

FIG. 14A shows additional details of an alternative paddle wheel that may be used in a carrier;

FIG. 14B shows additional details of a paddle wheel that may be used in a carrier;

FIG. 15 shows a front section of a carrier vehicle with a second example device for collecting and/or dispersing items;

FIG. 15A shows an alternate embodiment of a collection device;

FIG. 16 shows additional example features of a carrier;

FIG. 17 is a flowchart showing a range of steps associated with an example system for playing an online game.

FIG. 18 is a flowchart showing an example game page for the game of FIG. 17.

FIG. 19 is a flowchart showing example steps of a race for the game of FIG. 17.

FIG. 20 is a graphical representation of an example game page for the game of FIG. 17.

FIG. 21 is a graphical representation of an example activity for the game of FIG. 17.

FIG. 22 is another graphical representation of the example activity of FIG. 21.

FIG. 23 is another graphical representation of the example activity of FIG. 21.

FIG. 24 is another graphical representation of the example activity of FIG. 21.

FIG. 25 is another graphical representation of the example activity of FIG. 21.

FIG. 26 is another graphical representation of the example activity of FIG. 21.

FIG. 27 is an example pop through logo.

### DETAILED DESCRIPTION

A set of interrelated items, such as toys, toy vehicles, track sets, electronic games, interactive websites, cartoons, card games, and more are described individually below, along with examples of how the items may interact or interrelate to each other. In one example, a common theme may be used that ties these various products together, such as a racing theme. Such a theme may enhance the experience of the interrelated items. Any suitable theme may be applied to such items, including, but not limited to dinosaur themes, movie, television, racing, book or character-based themes, etc. Note that while individual items, systems, or methods may be described, the present disclosure includes any combination of the various items, systems, or methods.

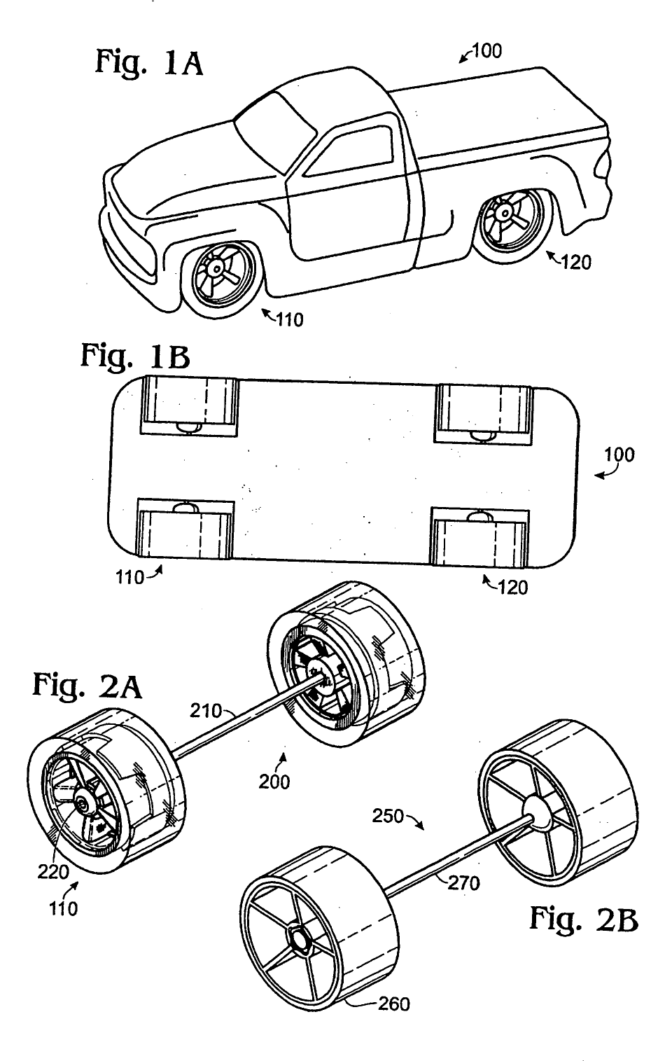

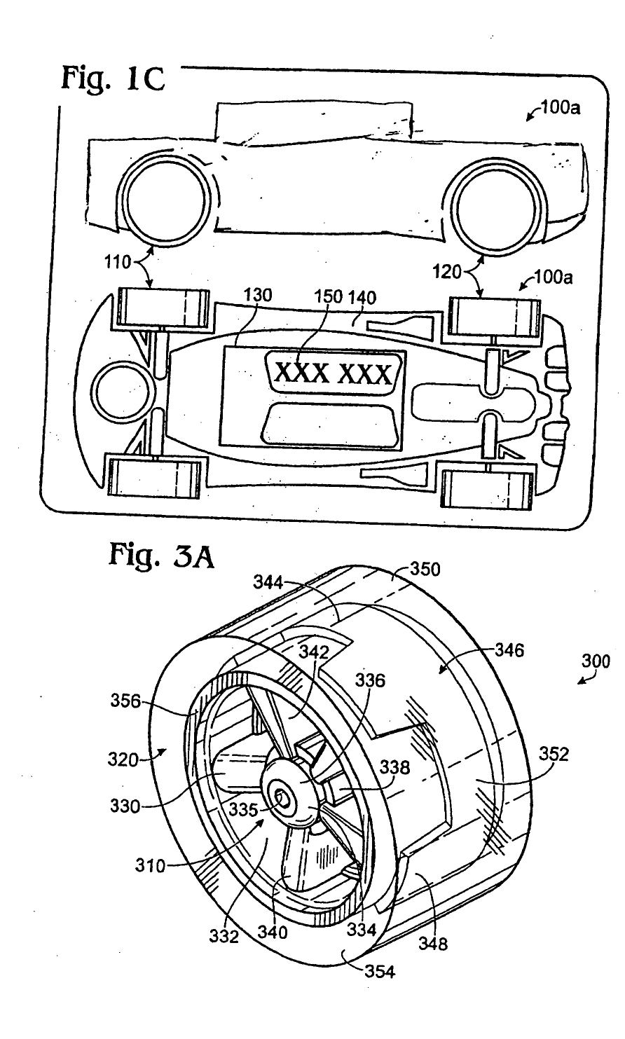

For exemplary purposes, an example scale vehicle, which may be a model and/or toy vehicle, and associated parts and manufacturing processes are described with regard to FIGS. 1-9. The model vehicle may be a toy vehicle which may have various features. The features may enhance the playability with the vehicle, may interrelate with other items, or may provide linkage and/or access to games and the like. For example, the model vehicle may include features, such as transparent or translucent regions, more exciting looking wheels, improved body construction and performance, laser etched codes, or combinations thereof. Further, the toy vehicle may be shaped or include markings, components or other indicia, which identify the vehicle as part of a family or team of vehicles. Also, various features of the present disclosure are applicable to products other than toys, and other than vehicles. For example, as described below, laser etched codes may be used on dolls, action figures, game pieces, or other toys or toy components.

FIGS. 1-7, 10, and 13-16 are drawn approximately to scale, although different figures may have different scales. Alternatively, the relative size, shape, and/or dimensions may be modified.

Referring now specifically to FIG. 1A, it shows a model vehicle 100, which in one example, may be a 1/64 scale toy vehicle. However, various other scales may be used, such as 1/10, 1/50, 1/100, 1/120, 1/200, and therebetween. The model vehicle can be a collectible item, and/or may be a performance vehicle that can be configured to be used on associated tracks and/or other equipment. While FIG. 1A shows an example toy truck, the vehicle may be of various types, such as a car, a sports car, a station wagon, a sport utility vehicle, a dune buggy, a motorcycle, a unicycle, an 18-wheeler, a dump truck, a sled, a snowmobile, a jet-ski, a boat, a hovercraft, earthmoving equipment, bicycles, tricycles, a rocket, a spaceship, fantasy vehicles, or any other suitable vehicles.

Toy vehicle 100 is shown in FIG. 1A having front wheels 110 and rear wheels 120. While two sets of wheels (with two wheels each) are shown for an example toy car, the toy vehicle may have more or less wheels, which may or may not be in sets. Further, the sets may have more than two wheels, such as, for example, three, four, etc. For example, the toy vehicle may be a motorcycle with a front wheel and a rear wheel. Alternatively, it may be a vehicle having three sets of two wheels. The vehicle may be a remotely-controlled (RC) vehicle that includes a power source to drive one or more wheels of the vehicle, or any other method of propulsion. In such an example, a separate controller may be provided to be operated by the user (either wired or wireless) to control direction of travel, speed of travel, and/or other aspects of the vehicle, or combinations thereof.

As described in more detail below, in some embodiments, it may be desirable to utilize “see-through” aspects, such as translucent or transparent wheels for toy vehicles. Various alternative embodiments describing see-through wheels are included. For example, one or more of the front and/or rear wheels may have certain translucent or transparent aspects. Translucent or transparent aspects may be in only front wheels, or in only back wheels, or in only one side of the vehicle, or in only outer wheels of sets having more than two wheels. Further, translucent or transparent aspects may be in only portions of the wheels, such as described in more detail below. Further still, different wheels may have different translucent or transparent aspects, such as described in more detail below.

Note that wheel, as used herein, may include any substantially cylindrical or spherical device, including discs, rings, rollers, etc. configured to roll or rotate along a surface, or devices that appear to have such structure or function.

In some embodiments, a wheel with at least two parts, portions, or sections, may be used which can provide the see-through aspects, yet still enable efficient and cost-effective manufacturing. In another example, a co-molding process may be used to manufacture the wheel and obtain a desired translucent or transparent look and function, while still providing acceptable performance and manufacturability. Still other approaches as described herein may be used.

While FIG. 1A shows vehicle 100 concealing at least a portion of wheels 110 (or 120), in an alternative embodiment all of wheels 110 (or 120) may be visible.

FIG. 1B shows a bottom view of vehicle 100 and the front and rear wheels 110 and 120. FIG. 1B also shows how the wheel and shaft assembly (see FIG. 2) is coupled to vehicle 100.

FIG. 1C shows an alternative side and bottom view of an alternative vehicle 100a having wheels 110 and 120. In this example, a code block 130 is included on the bottom of the vehicle chassis 140. A code 150 may be included within code block 130. Although shown as a defined code block, in some embodiments, the code may appear without a defined code block, or may be distributed about various portions of the vehicle or chassis.

Any suitable code, symbols, image or message may be used for code 150. In one example, a six-digit code 150 (represented by six Xs) is used having a first portion of three digits and a second portion of three digits. Although shown as having six digits, any number of digits may be used and be within the scope of the disclosure. Further, the code can include alphanumeric digits, in upper and/or lower case, binary numbers, as well as other symbols, such as, for example, <, >, /, +, −, ˆ, #, and/or | or fantastical, whimsical or imaginative symbols, pictures, images, etc. In one example, symbols found on keyboards may be used.

Code 150 may be linked with an inter-related item. For example, code 150 may be used to provide access to or be used with a game, an electronic game, a card game, a board game, a web-based or Internet game or site, a prize, a lottery, a DVD, a CD-ROM, etc. Thus, in some embodiments, a user may reproduce the code into an electronic interface device, such as a computer or gaming device. Reproduction of the code may result in a computer output based on the code or based on a plurality of codes. In some embodiments, the computer output may include theme-based content which is dependent on the entered code or codes. For example, such codes may provide a user with access privileges to special sites, boards or levels, access to various powers or skill sets, access to previously unavailable information, access to new characters, access to historical or other factual information related to the vehicle from which the code was entered, etc. For example, the codes may be bonus content codes or game codes. The bonus codes may unlock bonus content, such as vehicle specific or item specific downloadable content or background information. As another example, such codes may result in content related to the toy vehicle or inter-related item upon which the code was provided, or enable electronic racing or gaming with the vehicle upon which the code was provided.

In one embodiment, the code may unlock one or more features that give a vehicle a personality. For example, the code may enable a vehicle's personality to come to life during a computer or gaming experience. Or, different codes may give a vehicle (or group of vehicles) different personalities, and/or unlock further aspects of a vehicle's personality and/or change a vehicle's personality, permanently or temporarily. Still further, codes may enable access to track layout designs, special track features so that more exciting tracks may be desired, or other track features. Further still, codes may enable the ability to design computer tracks that can be used in computer and/or an on-line racing games.

In some situations, a user may select a vehicle or a set of vehicles to obtain access to specific codes. A user may be desirous of obtaining the codes in order to access games, sites, powers, characters, etc. The codes may enhance the play experience for the user. Additionally, such codes may enhance the collectibility function of the vehicles.

While FIG. 1C shows a laser etched code applied to a vehicle, such a code may be applied to numerous products, such as toys, dolls, scale vehicles, or combinations thereof. Moreover, codes may be promoted on movies, cartoons, websites, media releases, emails, packages, etc. As discussed above, such a code may enable access to various features through the Internet, computers, networked computers, DVD, games, etc.

By applying or locating a human-readable code on a collectible item, various issues may be addressed. For example, the code may be less likely to be lost, or traded separately from the item, and additional packing requirements (that might otherwise be used to supply the code) may be reduced. Further, in the example where a laser etching process is used to form the code on the item, a large variety of codes may be used, if desired. Further, the codes may be constantly changing, perhaps even different codes on every single item produced, in some examples.

In one embodiment, to provide increased flexibility, an approach that uses laser etching to add codes to collectible items, such as vehicles, may be used. Since the laser can be reprogrammed as often as necessary, changes to the mold are no longer required to change codes on a given product. Further, more automated manufacturing can be used since computer generated codes can be used and fed to the laser etching machine during the manufacturing process, thereby avoiding slow, time consuming, manual labor to change codes. Further still, such an approach may be extremely cost effective, and may be applied to a variety of different materials. It also can produce codes that are more difficult to counterfeit, thereby providing more security in the collection. Moreover, the code may be more durable, and less likely to rub off or become unreadable (which degrade long term collectible value of cars with certain highly valued codes in the trading market). The laser etching process may also be advantageous at it may be used on a variety of surfaces, so that different items in a series (with different materials) may have similarly formed codes, or the code may be moved to different locations on an item with different parts formed of different materials.

In one example, code may be applied to a bottom of a chassis of a scale vehicle (such as a toy vehicle), although it may be applied in various other locations, such as the side, top, on the wheels, in the wheels, or inside the vehicle.

As noted above, the code may be laser etched onto plastic and/or metal components, such as a chassis of a toy vehicle. Various types of lasers may be used, including commercially available laser cutting machines. In another example, the code may be applied to a painted metal surface. In a case where the metal is painted a dark color (such as black), the laser etching may produce a light color (such a silver or white) code. Further, in one example, the laser etching can produce a code that is substantially smooth with the surface of the material when felt by a human.

The thickness of the laser etched code may be on the order of less than 1/32 of an inch, and the size of the letter and/or symbols may be on the order of 1/16 of an inch.

Turning now to FIG. 2A, it shows wheel and shaft assembly 200, which may be incorporated into vehicle 100 or 100a, for example. In this example, assembly 200 includes wheels 110. However, assembly 200 may be a front, rear, mid, or other wheel set for vehicle 100. Assembly 200 further includes shaft 210, which in one example, may be formed of metal, such as steel, aluminum, or variations thereof. In one example, the diameter of shaft 210 is approximately 1/16 of an inch. In other examples it may be less than ⅛ of an inch, or less than 1/16 of an inch. Shaft 210 may have a head 220 on each end to retain wheels 110. Wheels 110 may be configured to rotate about shaft 210 independently of each other, or in unison. In one example, the head is formed by placing wheels 110 onto shaft 210, and then performing a metal forming process that compresses or deforms the shaft to form heads 220 on each end.

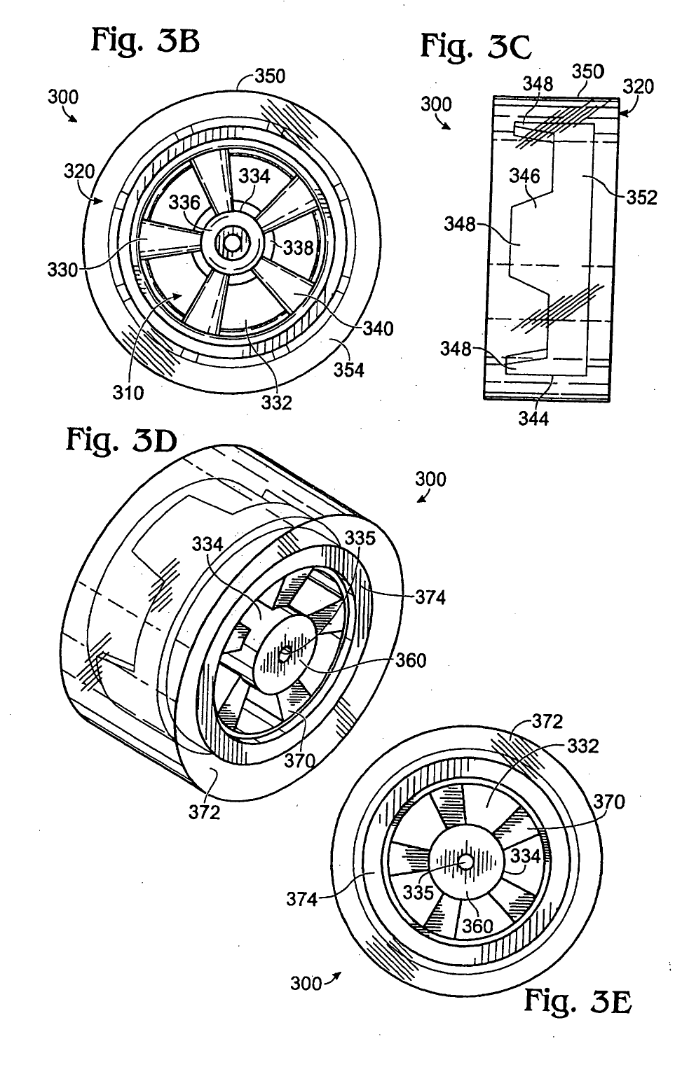

While FIG. 2A shows an example of a two wheel system, various other options are possible. For example, the assembly may have a single wheel or more than two wheels. Further details of wheels 110 are described in more detail below with regard to FIG. 3 and others.

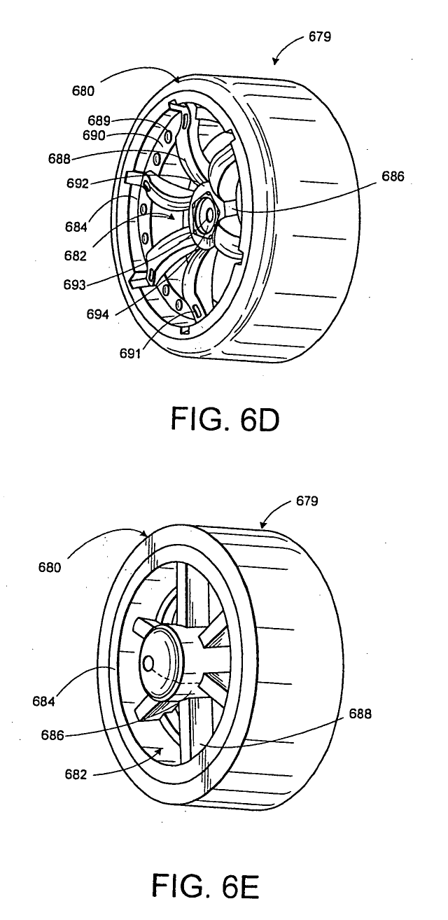

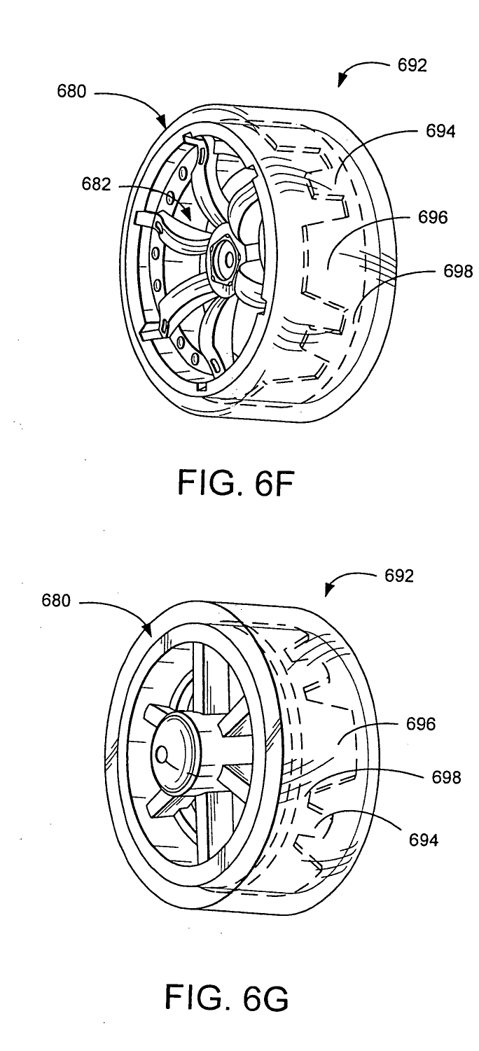

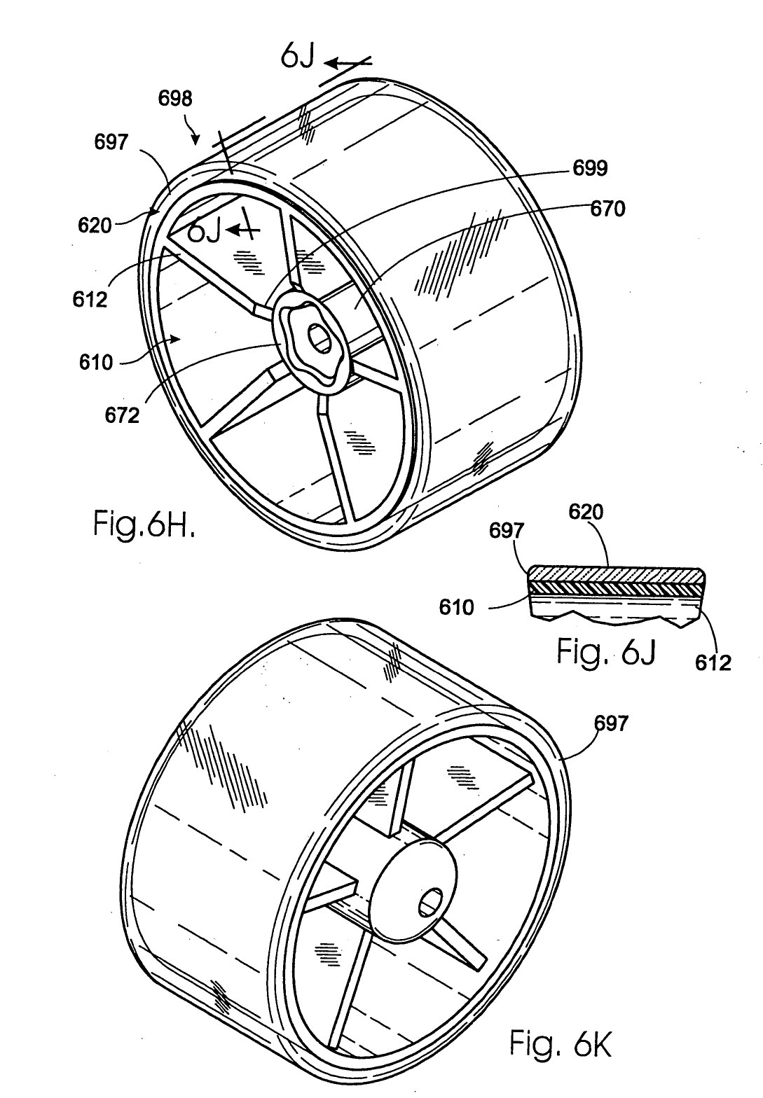

FIG. 2B shows an alternative wheel and shaft assembly 250 using alternative wheels 260 and metallic shaft 270. Further details of wheels 260 are described in more detail below with regard to FIG. 6.

Referring now to FIG. 3, an example wheel with see-through aspects is described, where alternative embodiments are shown in FIG. 6, for example. The translucent or transparent wheels can provide an interesting and new look that can increase the desirability of the vehicle for collection and play. However, it may be difficult to construct a translucent or transparent wheel that meets cost, durability, and manufacturing objectives, while also maintaining other features, such as acceptable track performance and the ability for decoration with a desired appearance. These difficulties may be experienced with high volume situations where cost and manufacturing concerns are of great concern, or even in low volume production. Various embodiments described below address these issues, as well as others.

Referring now specifically to FIG. 3A, it shows a three dimensional view of an example wheel 300 that may be used in assembly 200. Wheel 300 may be used for the wheels shown in FIG. 1A or 2A, for example. Wheel 300 is shown in FIGS. 1A, 1B, and 2A, for example. Wheel 300 is shown having at least two portions, an inner portion 310 and an outer portion 320. In this example, outer portion 320 is configured to interface a vehicle with a surface (not shown), such as a floor, road, track, or other vehicle. Therefore, outer portion 320, in one example, acts as a tire section of the wheel. Inner portion 310, in one example, is configured to interface the wheel 300 to a shaft, such as shaft 210. Therefore, inner portion 310, in one example, acts as a hub section of the wheel that may include a bearing surface relative to the shaft.

In one example, outer portion 320 includes translucent or transparent materials (that may have higher friction), while inner portion 310 includes materials that decrease friction at the bearing surface. As such, by using translucent materials in non-bearing sections of the wheel, translucent or transparent wheels may be configured to maintain bearing performance. In this way, at least a two-part wheel may be used to reduce bearing surface friction and potentially enabling improved vehicle performance on tracks, while providing a desired see-through appearance. Having increased track performance can increase a vehicle's collectability, and increase the play experience.

Also, since some materials with a translucent or transparent look may be difficult to form into a single wheel, by using at least a two-part wheel, more efficient manufacturing may be achieved.

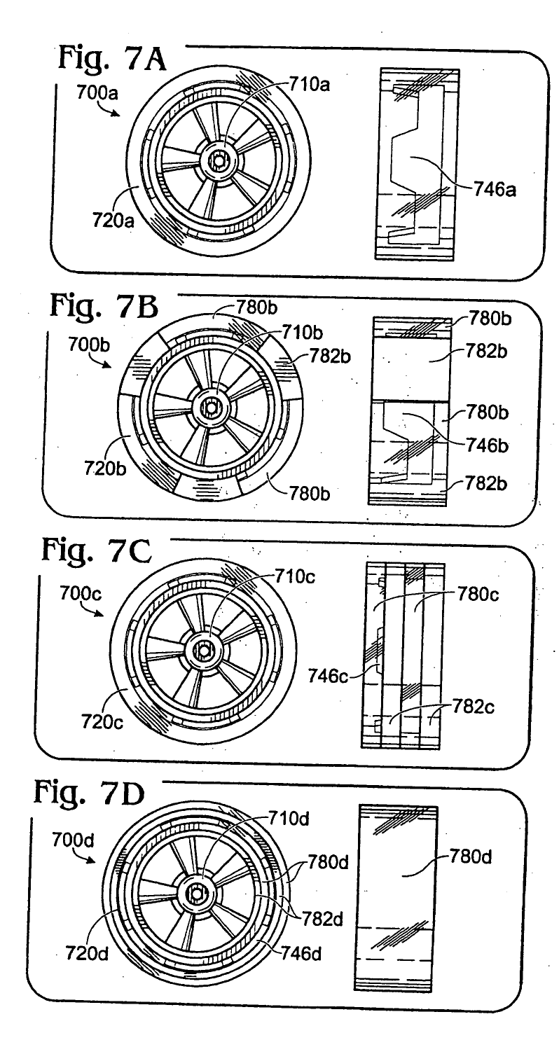

Returning to FIG. 3, while the example of FIG. 3 shows only two portions, additional portions may be used, such as intermediate inner portions along a radius of the wheel, or additional and/or separate portions along the width of wheel, such as described below with regard to FIG. 7 below. In one example, inner and outer portion 310 and 320 may form a single, unitary, wheel. Also, while certain portions may be referred to as “inner” or “outer” portions, this may only be a relative relationship to other portions or components. For example, in one example, a third portion (not shown) may be placed between portion 310 and 320, where the third portion has certain features that are at least partially visible through translucent or transparent sections of portion 320. In this case, the third portion may be referred to as an inner portion, since it is at least partially within portion 320. Likewise, a fourth portion (not shown) may be placed outside portion 320, where the third portion has certain features that are at least partially visible through translucent or transparent sections of the fourth portion. In this case, portion 320 may be referred to as an inner portion, and the fourth portion may be referred to as an outer portion since it is at least partially outside portion 320.

In the example of FIG. 3A, inner portion 310 includes five spokes 330, creating five voids 332 that extend through wheel 300. While five spokes are shown in this example, more or less spokes may be used, such as six, for example. Spokes 330 are shown extending from an inner cylinder 334, having a hole 335 therethrough configured to be coupled to a cylindrical shaft. An outer protrusion 336 of spherical shape extends from cylinder 334. Also, an outer cylinder 338 of shorter depth is positioned around inner cylinder 334, and between spokes 330. Also, spokes 330 have a curved outward facing surface 340, and flat sides 342.

Inner portion 310 also has an exterior surface 344 with protrusion 346. In the example where outer portion 320 is at least partially translucent or transparent, features, such as surface features, of inner portion 310, such as stepped protrusion 346, may be visible or partially visible through outer portion 320. Specifically, as described in more detail below, a section of outer portion 320 may have a different light transmissivity than a section of inner portion 320, thereby creating a transparent or translucent appearance of outer portion 320.

For example, outer portion 320 may have material properties that transmit and/or diffuse light (or that diffuse light of specific wavelengths to create certain color appearances) to a greater extent than material properties of inner portion 310. In one specific example, outer portion 320 diffuses visible light of specific wavelengths to create a translucent colored effect, and inner portion 310 reflects and/or absorbs visible light, or combinations thereof.

In other words, transparent materials are able to transmit light directly, while translucent materials are able to transmit light but also diffuse the light to some extent. For example, a translucent appearance may include a semi-transparent appearance. Transparent or translucent materials that appear to have a certain color have properties that transmit light at a specific wavelength, or range of wavelengths. Thus, by using material with different light transmission and/or diffusion properties, features of inner potion 310 may be visible or partially visible through outer portion 320.

In one embodiment, the entire outer portion 320 is translucent or transparent and the entire inner portion 310 is opaque, thus giving the appearance that wheel 300 has a translucent or transparent tire. However, in alternative embodiments, both portions may be translucent or transparent or partially translucent or transparent. For example, outer portion 320 may include at least one material which has higher light transmissivity than a material of inner portion 310. Alternatively, outer portion 320 may include at least one material which has lower light diffusivity than a material of inner portion 310. In still another embodiment, outer portion 320 may include at least one material which has lower light absorption than a material of inner portion 310. Still further, various combinations of the above properties may be used, where, for example, outer portion 320 may include at least one material with different transmissivity, diffusivity, reflectivity, refractivity, and/or light absorption, or combinations thereof, than a material of inner portion 310. In yet another embodiment, various combinations of the above properties may be used, where, for example, outer portion 320 may include at least one material with different transmissivity, diffusivity, reflectivity, refractivity, and/or light absorption, or combinations thereof, for a wavelength (e.g., color) or specific wavelengths (colors), than a material of inner portion 310.

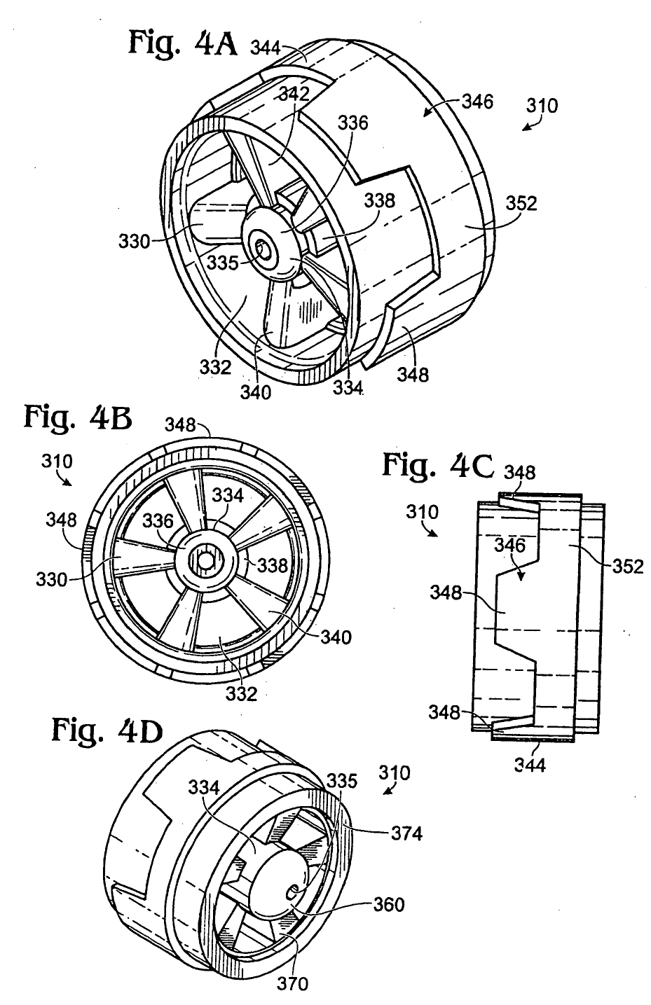

Returning to FIG. 3A, protrusion 346 includes five extensions, or steps, 348 where the depth of protrusion 346 is increased relative to un-extended region 352. While five extensions are shown, more or less may be used. As shown in FIG. 3A, extensions 348 extend outward toward the outer side of wheel 300, and may be tapered to become narrower, thus having a trapezoidal shape. Further details of the structure of protrusions 346 are described in more detail below with regard to FIG. 4. Also, different shaped protrusions, such as triangular or trapezoidal, may be used, for example. Further, still other shapes of protrusions may be used, if desired. The protrusions may also be of a repeating shape nature, or may each be of different shapes. Such protrusions may be shaped such as to be used as identifying indicia for the vehicle. Further such protrusions may be shaped to include messages, images, codes, or to imitate or make the wheels or vehicles appear to be in motion.

In some example, protrusions 346 also may act as interlocking grooves and steps with outer portion 320 to increase friction between the two portions in the direction of rotation of the wheel. In this way, potential slippage in the direction of rotation is decreased. Also, the angular shape of extensions 348 may further provide for interlocking between the inner and outer portion.

Further still, protrusions 346 may hold the outer portion (which may include or be a tire section) during a wheel manufacturing process, such as a co-molding process or other process), thereby enabling improved manufacturability, while also providing an interesting appearance that may increase item collectibility and/or value.

Inner portion 310 may also include an outward outer face or surface 356 that is substantially flat and is substantially planar with exterior surface 344 of outer portion 320 (discussed below). Outward outer face 356 may also be substantially parallel to flat outer face 372 of outer portion 320 (discussed below). Inner portion 310 may also include an inward facing surface 374 that is substantially flat and is substantially planar with surface 372 of outer portion 320 (discussed below). In an alternative embodiment, outward outer face 356 and inward facing surface 374 of inner portion 310 may extend past outer portion 320, or end within outer portion 320.

In one example, outward outer face 356 may be marked or stamped with a hot stamping process. The stamping may provide a silver, chrome, or gold plating appearance, such as by a silver hot stamping process. Note that other plating colors may also be used. Such stamping may be used as identifying indicia or increase the desirability of the vehicle for collection or play. It should be appreciated that other decorations may be applied on outward outer face 356, or no decoration may be applied.

Outer portion 320 may be translucent and/or transparent, wholly or in part. In the drawings, the example translucent and/or transparent aspects are indicated with the conventional drawing designation for such a feature. While this example shows the entire outer portion being a translucent and/or transparent material, various other examples are described below with regard to FIG. 7. Further, the level of transparency (or transmissivity, or diffusivity) of the outer portion may vary, as well as the color of outer portion 320 (by varying, for example, the wavelength of light transmitted). Colors may include: green, blue, smoke, red, yellow, clear, white, grey, or others. In some embodiments, the outer portion of the wheels may be of a single color, while in others, multiple colors may be used.

The various coloring of the wheels may be used to identify the vehicle or a vehicle type. For example, vehicle 100 in FIG. 1 and vehicle 100a in FIG. 1A may both include translucent/transparent wheels of the same color, e.g. green. By providing wheels of the same color, it may be understood that such vehicles are within the same set, team, or group. Further, as another example, the wheels of vehicle 100 may be a first color, e.g. red, and the wheels of vehicle 100a a second color, e.g. blue, and the various wheel colors may be used to identify the vehicles, or identify that the vehicles are of different sets, teams, or groups. Additionally, the coloring of the wheels may correspond to other interrelated items, such as track sets, games, cartoons, carrier vehicles, etc. Further still, common coloring of a vehicle's body and wheels, for example, may be used. For example, color matching and/or coordination may be used to coordinate colors of the wheel and vehicle (e.g., green translucent wheels may be used with a vehicle having green coloring and/or details). Also, different shades of the same color may be used for translucent portions of the wheels and on the vehicle body.

Outer portion 320 may have a smooth outer cylinder surface 350 and smooth outer face surface 354, and may be mated physically contiguous with exterior surface 344 and protrusions 346. However, in an alternative embodiment, less contact between inner portion 310 and outer portion 320 may be used. Outer cylinder surface 350 may have a smooth finish to enhance the translucent or transparent look of the wheels and enable physical structure features and/or shapes of inner portion 310 to be visible (or at least partially visible), such as protrusions 346, for example. Further, symbols, pictures, text, radial steps, circumferential steps, recesses, other decorations, and/or combinations thereof may be placed on inner portion 310 so that they are visible through translucent or transparent sections (if any) of outer portion 320. In one example, the features may be located on exterior surface 344. For example, writing, symbols, etc., may be disposed on exterior surface 344 of inner portion 310, either on the protrusion 346 or not, so that it (or at least some of the feature) may be visible through at least some of outer portion 320.

In still another alternative example, outer cylinder surface 350 can have a sanded and/or more granular finish to obscure features that may be visible through translucent or transparent sections. In some embodiments, the rougher finish may provide increased traction of the wheels on a track, and may improve performance of the vehicle on the track.

In one example, inner portion 310 and outer portion 320 are formed of similar plastics, such as acrylonitrile butadine styrene (ABS). Other plastics or resins that may be used include delrin, polyethylene terephthalate (PET), high-density polyethylene (HDPE), polyvinyl chloride (PVC), low-density polyethylene (LDPE), polypropylene (PP), or polystyrene (PS).

In another example, inner portion 310 and outer portion 320 are formed of dissimilar plastics, such as the following: delrin, nylon, ABS, thermoplastics, or those listed above. In one example, thermoplastics may be used for the outer portion and/or inner portion to further facilitate insert molding and/or co-molding. Note also that various coloring may be added to color the plastic of the inner and/or outer portions. In one example, the inner portion can have a silver color, while in other cases it may be white, or black, for example.

Suitable thermoplastics may include, for example, polyvinyl chloride, acrylonitrile-butadiene-styrene, polycarbonate, polystyrene, polyethylene, polypropylene, polyethylene tetrephthalate-glycol, nylon, and RIM urethanes. Polyolefin homopolymers and copolymers (ionomers, etc.) may be inexpensive thermoplastic resins which may have suitable molding properties and may also be suitable for use. Additionally, various thermoplastic elastomers, such as the TPO's (thermoplastic olefin) elastomers, may be employed. Also note that materials other than plastics may also be used for the wheels, or wheel components.

As described above, costs of manufacturing a translucent or transparent wheel may be reduced by manufacturing at least a two-part wheel with at least one part comprising partially translucent or transparent material. However, it is also possible to manufacture a translucent or transparent wheel with the features above in a single piece. However, by using at least a two-part wheel, along with co-molding in one example, the desired appearance, performance, cost, and manufacturability may be achieved.

As described above, features of inner portion 310 may be at least partially visible through an at least partially translucent or transparent outer portion 320. The feature may include at least one of texture, words, symbols, a flat surface, a ridge, a stepped protrusion (such as 346), or combinations thereof.

Note that while FIG. 3A shows both inner portion 310 and outer portion 320 each formed of a single piece, in an alternative embodiment these may be divided into multiple pieces and separate pieces that are formed together via insert molding, or co-molding, for example. Further note that while many of the edges and corners of FIG. 3A are shown as sharp, rounded edges may also be used.

FIGS. 3B and 3C show front and side views, respectively, of wheel 300, with like parts numbered with like numbers. FIG. 3D shows a three dimensional rear view of wheel 300, and FIG. 3E shows a rear view of wheel 300.

FIG. 3D shows additional details of the rear of wheel 300, including inner cylinder 334 having a flat exterior face 360 which is located facing the interior of the vehicle, for example. Further, FIG. 3D shows flat exterior surface 370 of spokes 330.

FIG. 3E shows a rear view of wheel 300, showing details that may face the vehicle, such as vehicle 100. Specifically, FIG. 3E shows how in this example, spokes 340 taper outward toward the outer portion, as well as voids 332.

While FIG. 3A-E are drawn approximately to scale, the features and elements may be changed and altered to be of different sizes and shapes. In the example shown, the scale of FIG. 3B is approximately 5.4:1. In other words, in one example, wheel 300 has an outer diameter of approximately ⅝ of an inch. Note that various other sized wheels may be used, although the relative sizing of the components may be consistent (or may be varied). Also, in some examples, different sized wheels may be used in different locations on a vehicle. For example, the front wheels may be smaller (and/or narrower, thinner, etc.) than the rear wheels. For example, the width of the wheel may be approximately 3/16 of an inch, 9/32 of an inch, or other. Likewise, the outer diameter of the wheel may also be approximately 15/32 of an inch, ½ of an inch, or others.

FIG. 4A shows inner portion 310 (which may be unitary, or comprised of several separate sections) without outer portion 320. While in one example, inner portion 310 is formed of a single section, in other embodiments multiple pieces or sections may be used.

FIG. 4A uses common reference numbers as used in FIG. 3. For example, FIG. 4A shows an example substantially cylindrical outer surface 350 with flat outer faces 354 and 372. FIG. 4B shows a front view of inner portion 310, and FIG. 4C shows a side view of inner portion 310.

Referring now to FIG. 4D, an alternative embodiment is shown where exterior face 360 (which faces an inner side of a vehicle, in one example) is replaced with a substantially rounded exterior face, which may be spherical in shape. Such a structure may reduce the contact surface between the wheel and the vehicle, thereby reducing friction and improving vehicle performance.

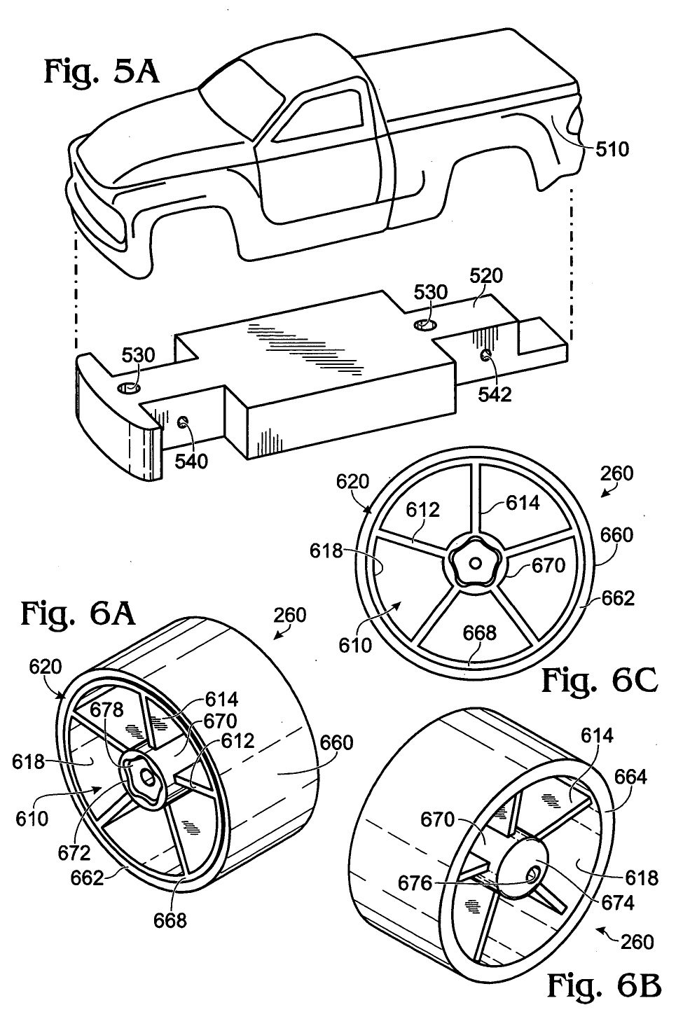

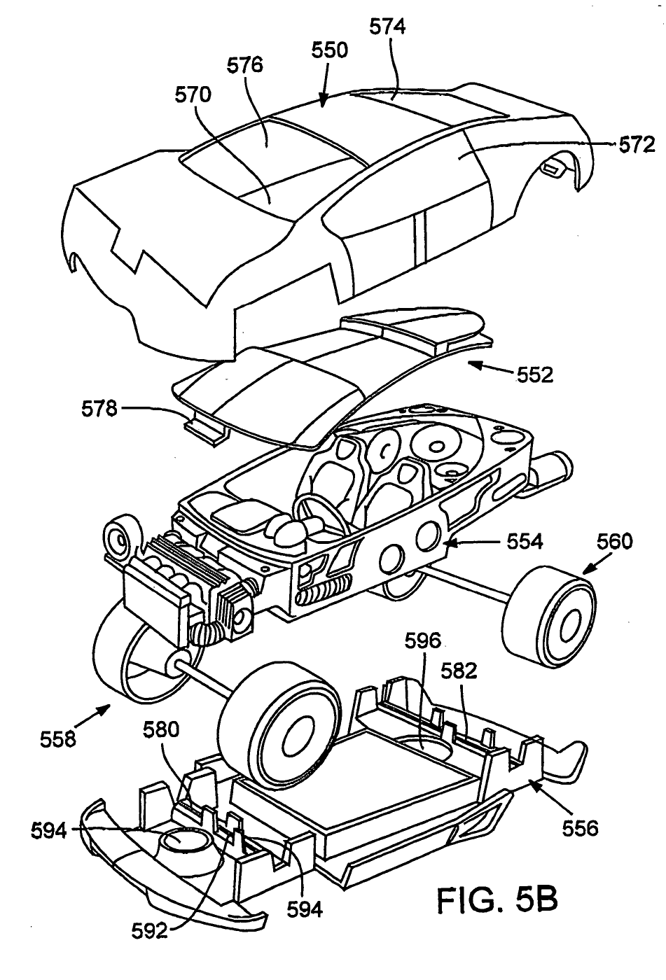

FIG. 5 shows body section 510 and chassis section 520 of an example vehicle. While these sections correspond to the example vehicle of FIG. 1, various alternative types of vehicle may be used as previously described. In one example, body section 510 comprises a plastic, such as those listed above, and chassis section 520 comprises metal. However, other materials, or combinations of materials, may be used. For example, body 510 may be plastic or metal and chassis 520 may be plastic or metal. FIG. 5 also shows front and rear holes 540 and 542 configured to hold a wheel, or set of wheels (e.g., wheels 200 or 250), via a shaft, such as either of shafts 210 or 270. In one specific example, the chassis may be die cast of an alloy comprising zinc and plated, painted, or combinations thereof.

In an alternative embodiment, chassis section 520 may be configured to hold wheels where each wheel has only a single shaft coupling the wheel to the chassis. In other words, each wheel has a separate shaft. Alternatively, some wheels may share a shaft, while other shafts have a single wheel.

In one example, body section 510 is coupled to chassis section 520 via a snap fit connection. However, other couplings can be used in the alternative, or in addition, such as, for example, screws, bolts, welds, rivets, combinations thereof, or others. For example, holes 530 may be configured to mate with pegs (not shown) of body section 510. When manufacturing, after coupling section 510 to chassis section 520, the pegs may be altered to secure a connection. Alternatively, the pegs of body section 510 may be configured to enable a snap-fit connection between body section 510 to chassis section 520. For example, the pegs of body section 510 may have one or more structural features, such as protrusions, detents, or recesses with corresponding mating structures on the chassis section, to enable coupling of the two sections.

In the example of a metal chassis and a plastic body, it may be possible to obtain a vehicle with a lower center of gravity (CG) and thereby obtain improved track performance, or improved performance in other venues.

Note that decorations, markings, and/or painting may be applied to one or both of the body and chassis, as discussed in more detail below. Also, in this example, body and chassis 510 and 520 may each be a single, unitary piece. However in an alternative embodiment, the body and the chassis may be formed of multiple pieces, or may be formed in multiple sections.

As discussed in more detail below, a laser etched code, for example a six-digit code of two three-digit sections, may be applied to chassis 520, such as described above with regard to FIG. 1C. In one example, the code may be laser etched onto the bottom side of chassis 520 so that it is visible (and/or human-readable) when the chassis is upside-down. Note that additional features, symbols, images, text and/or codes may also be applied to, or laser etched on, chassis 520. Alternatively, codes may be laser etched on body 510, or other parts of the vehicle, such as the wheels.

In still another example, body and chassis 510 and 520 may be configured to enable a portion of body 510 to protrude through chassis 520. The protrusion may be in various shapes, including various designs or indicators, engine or powertrain parts, and/or exhaust parts, or combinations thereof. In this way, such features may be made to have more of a contrast when the bottom side of the vehicle is viewed.

Referring now to FIG. 5B, an alternative embodiment of a vehicle and its components is shown. In this example, exterior body section 550 is shown, along with a window section 552, interior body section 554, and chassis 556. Further, front and rear wheel assemblies 558 and 560 are also shown, which may include assembly 110 or 250, for example. FIG. 5B shows an assembly view illustrating how the components are assembled, with the vertical direction illustrating relative component positioning.

In this example, body 550 comprises ABS plastic painted as described below herein with regard to FIG. 9, window 552 comprises a k-resin, interior section 554 comprises VUM (which may provide a chrome appearance), and chassis 556 comprises metal (such as zinc, or ZAMAC) which may be painted.

As shown in FIG. 5B, exterior body section 550 includes several holes 570, 572, 574, 576 corresponding to a front windshield, side window, rear windshield, and opposite side window, respectively. Window section 552, which in this case is a single piece to reduce manufacturing cost and complexity, is configured to mate with these holes, and be at least partially held by clip 578. Interior body section 554 is shown with various features to mimic vehicle components, such as seats, a powertrain, exhaust, etc. Further, interior body section 554 is configured to be coupled to chassis 556 and hold wheel assemblies 558 and 554. In one example, this is accomplished via the shaft locations 580 and 582, which include a plurality of retaining clips 590 and a recess 592 to hold and retain the shaft of the wheel assembly. Further, chassis 582 includes holes 594 and 596 configured to be coupled to one or more of the body sections, as discussed above with regard to FIG. 5A. In one example, one or more spin posts (not shown) may be included in one or more of sections 554 and/or 550, which may be used to align with hole 594 (and/or 596) during assembly.

FIGS. 6A-B show an alternative embodiment wheel 600, which may be used with a toy vehicle, such as vehicle 100 or 100a, or used to form a wheel assembly, such as in FIG. 2B, for example. Specifically, FIG. 6A shows a 3-D perspective from the outer side of the wheel, and FIG. 6B shows a 3-D perspective from the inner side of the wheel (although the wheel may be mounted in either direction, just as with regard to wheel 300). FIG. 6C shows a front view of wheel 600. In this example, wheel 600 is unitary and formed in a single piece. However, in alternative embodiments, it may be formed of multiple pieces or portions that are formed separately, or concurrently.

Wheel 600, which may be used as wheel 260, may have an inner section 610 and an outer section 620. Inner section 610 may include five spokes 612 which have inner surfaces 614 creating five voids 618. Although shown as having five spokes and five voids, the wheel may include any number of spokes or voids without departing from the scope of the disclosure. Further although the spokes and voids are shown to be of equal size respectively, different sized spokes and/or voids may be applied to the wheel.

Inner section 610 of wheel 600 also may include an inner cylinder 670 with a flat outer end 672 and a rounded inner end 674, which may be half-spherical in one example. Inner end 674 may protrude outward from inner cylinder 670 (and extend inward past the edge inward facing side surface 664, see below), thereby reducing potential friction between the inner edge of the wheel or tire and the vehicle. Inner cylinder 670 also may have a hole or aperture 676 therethrough configured to receive a shaft, such as shaft 270. Outer end 672 of inner cylinder 670 may also have a recessed feature, such as the five-sided star shaped feature 678. In one example embodiment, a head on a shaft, such as shaft 270, is sized to fit into recess 678, thereby providing a possibility for improved stability, and fit and finish appearance. While a five sided shaped recess is shown in FIGS. 6A and C, various other recess shapes may be used, such as circular, square, or others.

The outer section 620 of wheel 600 is cylindrical in shape, with an outer, flat surface 660, outward facing side surface 662, and inward facing side surface 664, relative to the vehicle. In the example of FIGS. 6A and C, outward facing side surface 662 includes a stepped inner surface 668. In one example, outward facing side surface 662 and inward facing side surface 664 are substantially parallel, and substantially perpendicular to surface 660.

In some embodiments, portions of wheel 600 may comprise an opaque plastic, while other portions of wheel 600 may include at least a translucent or transparent section. For example, wheel 600 may comprise at least an inner and outer portion (corresponding to inner section 610 and outer section 620), where the outer portion comprises a translucent or transparent plastic, and the inner portion comprises a less translucent or less transparent material, such as an opaque material.

As noted above, FIGS. 6A-C are drawn approximately to scale. In one example embodiment, the outer diameter of wheel 600 is approximately ⅝ of an inch, and the outer width is approximately 11/16 of inch. Further, the outer rim thickness of 662 may be approximately 1/16 of an inch or ⅛ of an inch, or less than ⅛ of an inch in some examples. The thickness of spokes 612 may be approximately 1/16 of an inch, ⅛ of an inch or less than ⅛ or 1/16 of an inch in some examples. In the example shown, the scale of FIG. 6A is approximately 5.4:1, within approximately +−20%. Note also that the relative sizing of the wheel features may also be adjusted.

While the above embodiment shows specific sizes and relative proportions that may be desirable, various modifications may be made. In other words, as noted above, the features and elements may be changed and altered to be of different sizes and shapes, if desired.

The configuration of wheel 600 may enable the wheel to obtain a low profile appearance, while maintaining vehicle performance during use on a track, and while still meeting cost and manufacturability requirements. In other words, it may be possible to achieve a desired relative sizing of various wheel aspects while meeting other requirements.

Referring now to FIG. 6D, still another alternative embodiment of a wheel that may include translucent or transparent aspects is shown. In this example, a six spoked wheel 679 is shown, although more or less spokes may be used, such as 2, 3, 4, 5, 7, 8, or others. This wheel of FIG. 6D may be used in place of any of the wheels disclosed herein, including the wheel of FIG. 2-4 or 6A-C, F-J, for example.

FIG. 6D shows inner portion 682 and outer portion 680, where outer portion 680 may act as a tire section, and inner portion 682 may act as a hub section. Outer portion 680 is shown with a rounded exterior (relative to a vehicle) edge, and a flat interior (relative to a vehicle) edge. In this example, both inner and outer portions 680 and 682 are opaque. However, in one example (see FIGS. 6F-G below) outer portion 680 (and/or inner portion 682) may comprise translucent or transparent aspects, such as described herein with regard to FIGS. 3-4, 6A-C, 6F-J, and 7, for example. Specifically, any of the materials, features, etc. described above with regard to FIG. 3, 4, 6A-C, 6F-J or 7 may be used in wheel 679.

Continuing with FIG. 6D, inner portion 682 includes an outer rim section 684 and an inner hub section 686, where the sections are connected by six spokes 688. The spoke may have a depth slightly less than the depth of the outer portion, as shown in FIG. 6E, or may be thinner in an alternative embodiment.

In this example, outer rim section 684 includes protruding knobs 689 which may provide an appearance of rivets. In this example, 12 knobs are shown, however, more or less may be used. The knobs 689 are located on recessed area 690 of outer rim section 684. In this example, the knobs are cylindrical in shape, however other shapes may be used if desired.

Spokes 688 are shown with a rectangular cross-section and a curved shape between outer rim section 684 and an inner hub section 686. Also, spokes 688 contain a recess 691 at the interface between the spokes and outer rim section 684, which continues partially into outer rim section 684.

Inner hub section 686 is shown with a cylindrical shape, and may include a spherical end facing a vehicle (see FIG. 6E) as described above with regard to FIG. 4D. Further, as shown in FIG. 6D, the outward facing end 692 of inner hub section 686 may include a hole 693 with an at least partially surrounding recess 694. In this example, the recess includes a 5-sided shape recesses, although other shapes may be used, such as the star shape of FIG. 6A (see 678).

Also, as described above with regard to FIGS. 3-4, inner portion 682 may include various features, such as features on its exterior surface (that interfaces to outer portion 680) that may be at least partially visible through outer portion 680. For example, protrusions with extended and non-extended regions may be used, if desired.

Referring now to FIGS. 6F-G, an alternative embodiment shows wheel 692 in FIGS. 6D-E, where outer portion 680 comprises translucent aspects. In this example, an alternative protrusion 694 (compared with protrusion 346) is used, where a second, less wide extension is added. Specifically, protrusion 694 includes five wider extensions, or steps, 696 where the depth of protrusion 696 is increased relative to un-extended region 698. Protrusion 694 also includes five narrower extensions, or steps, 694 where the depth of protrusion 694 is increased relative to un-extended region 698. While five extensions are shown of each width, more or less may be used. Further, extensions 694 may be less extended than extensions 696 (as shown), or equally extended (not shown).

Referring now to FIGS. 6H, J, and K, an alternative embodiment of the wheel shown in FIGS. 6A-C is illustrated. Specifically, wheel 698 is identical to the wheel of FIGS. 6A-C, except that cylinder 670 is less deep, so that spokes 612 extend outward past flat outer end 672. Further, a chamfer 699 is included, which may reduce stress at the juncture of the spoke and the hub.

Further, wheel 698 is shown with a translucent outer portion 620, and without any protrusions below surface 660. However, protrusions such as those described herein may be used to improve the juncture between the inner and out portions if desired. Also, in an alternative embodiment, the outer portion of FIG. 6H may be opaque, such as black.

FIG. 6J shows a partial cross-section, illustrating the rounded edge 697 on the inner and outer edge of outer portion 620, along with the angle of spokes 612.

Referring now to FIGS. 7A-D, exemplary alternative embodiments of wheel configurations are shown with various examples of translucent or transparent features that may be used on one or more wheels of toy vehicle 100, or 100a, or with the wheels of FIG. 3 or 6, for example. Specifically, FIGS. 7A-D show various combinations of translucent or transparent features and/or materials to obtain different still and in-motion effects, and therefore may increase play fun and excitement and collectibility, among achieving other effects. Note also that any of the above described wheels may be used on various other toys or products, such as, for example, doll roller skates, doll skateboards, spaceships, or others, as noted herein.

FIG. 7A shows a front and side view of an example of wheel 700a where the entire outer portion 720a of wheel 700a is made from a translucent or transparent material. In this example, inner portion 710a is opaque, and thus the protrusions 746a may be visible in the front and side views.

FIG. 7B shows a front and side view of an example of wheel 700B where less than the entire outer portion 720b of wheel 700b is made from a translucent or transparent material. Specifically, three radial sections 780b (which may be translucent or transparent or combinations thereof), and three opaque sections 782b of outer portion 720b are shown. Note that any number of translucent or transparent radial sections may be used, such as 1, 2, 3, 4, 5, 6, 7, . . . 20, for example. In this example, inner portion 710b is also opaque, and thus at least some of the protrusions 746b may be visible in the front and side views through sections 780b.

FIG. 7C shows a front and side view of an example of wheel 700c where less than the entire outer portion 720c of wheel 700c is made from a translucent or transparent material. Specifically, two sections 780C (which may be translucent or transparent) along the width of the wheel, and two opaque sections 782c of outer portion 720c are shown. Note that any number of translucent depth sections may be used, such as 1, 2, 3, 4, 5, 6, 7, . . . 20, for example. In this example, inner portion 710c is also opaque, and thus at least some of the protrusions 746c may be visible in the front and side views through sections 780c.

FIG. 7D shows a front and side view of an example of wheel 700d where less than the entire outer portion 720d of wheel 700d is made from a translucent material. Specifically, two circumferential sections 780c (which may be translucent or transparent), and two opaque circumferential sections 782d of outer portion 720D are shown. Note that any number of translucent or transparent circumferential sections may be used, such as 1, 2, 3, 4, 5, 6, 7, . . . 20, for example. In this example, inner portion 710d is also opaque, and however, due to outermost section 782d, none of the protrusions 746d may be visible in the side view, while edges may be visible in the front view.

While FIGS. 7A-7D show examples of translucent or transparent aspects that may be included for various toy wheels, various other translucent or transparent aspects may also be used. Further, features may be combined between the various embodiments, if desired.

Vehicles may have all wheels with the same or similar features, or some wheels with different, or no, translucent or transparent features. For example, all wheels may have translucent or transparent features, or only some of the wheels (e.g., less than all of the wheels) may have translucent or transparent features. Also, some wheels may have different translucent or transparent effects than other wheels. As an example, in a front and rear wheeled vehicle, the front wheels may be substantially opaque, while the rear wheels may have translucent or transparent features, or vice versa.

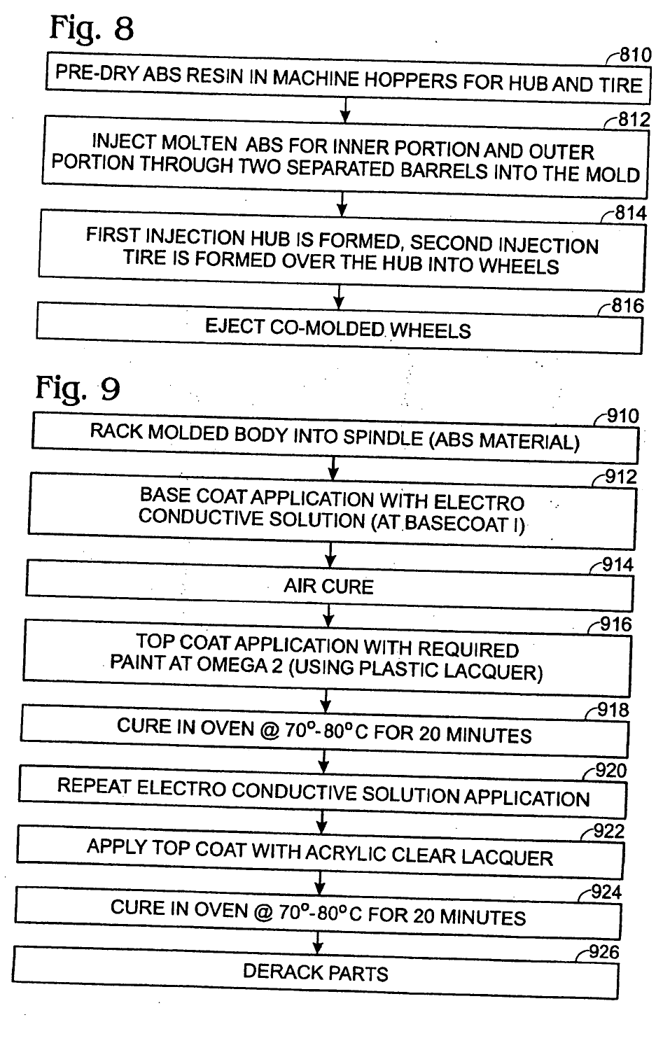

FIG. 8 shows a flow chart illustrating an example manufacturing process for forming at least a two-part wheel, which may include the wheels of FIG. 2-4, and 6, for example. Specifically, the manufacturing process includes a method for forming an inner portion and outer portion of a wheel in the example where the inner portion includes a hub section and the outer portion includes a tire section. As noted below, co-molding, or insert molding, techniques may be used. For example, the inner portion may be first formed, and then the outer portion may be formed around the inner portion. Alternatively, the inner and outer portions may be molded together. In still another alternative, the outer portion may be first formed, and then the inner portion may be formed within the outer portion. Also, while the process described herein is for a single wheel, it may be expanded to concurrently form a plurality of wheels. Further still, while the process is described for a two-part wheel, it may be used on wheels having more than two sections, or may be used to form only portions of a wheel.

Referring now specifically to FIG. 8, in step 810, ABS resin, or similar composition, for the inner and outer portions may be pre-dried in machine hoppers. In one example, as noted above, the inner portion includes a hub section and the outer portion includes a tire section. Next, in step 812, molten ABS for the inner portion and outer portion may be injected through two separated barrels into the mold designed to produce the forms described above herein with regard to FIGS. 2-4, for example. Then, in step 814, the first injection hub is formed, and the second injection tire is formed over the hub into a wheel. Then, in step 816, the co-molded wheel is ejected. If desired, the wheel may be decorated, such as via a hot silver stamp on an outer edge, as described above herein.

As noted above, the outer portion may comprise translucent or transparent ABS material. In this way, it may be possible to co-mold a wheel, such as the wheel illustrated in FIG. 3A, for example. Further, the co-molding process may affix the inner and outer portions so that they may form a unitary structure. Also, the process may be expanded for wheels having more than two portions or sections, or for wheels where the hub and or tire sections comprise multiple parts or portions.

FIG. 9 shows a flow chart illustrating an example manufacturing and painting process for a plastic item, such as a toy vehicle, a doll, accessories for toys, or other such items. Such a process may be especially useful for toy vehicles having a plastic body, where a high quality finished appearance may be desired in some cases.

Further, as noted above, toy vehicle 100 may be used with various track sets. As such, track performance may be a significant characteristic as to whether the toy vehicle is desirable by consumers. One approach to improve track play described herein is to lower the vehicle's center of gravity (CG), which can be at least partially achieved by using a plastic body. The plastic body may be combined with a metal or plastic chassis. Plastic bodies may also have the ability to show improved line details, due to potentially lower forming temperatures (e.g., <200 C) compared with die casting (e.g., >375 C).

While plastic bodies may have good definition, previous use of plastic bodies resulted in perceived cheap or poor quality vehicles in comparison to metal bodied vehicles. This perception may be due, in part, to potential issues in achieving high quality paint finish on plastics, when compared with metal. Specifically, high quality paint finishes may be relatively cost effectively obtained on metal surfaces via an electrostatic painting process, where the metal body is charged, and the paint it oppositely charged. Since most plastics are not conductive, such an electrostatic process generally may not be applied to the plastic bodies.

However, the approach described herein overcomes the above obstacles and improves plastic body paint quality, while maintaining cost effective manufacturing processes. As described in more detail below, in one example, a spray having a suspension of chargeable particles is applied to the body before painting. In this way, the body can then be charged (e.g., given a negative charge), so that charged (e.g., positively charged) paint can be used, thus enabling an electrostatic painting process. In this way, it is possible to obtain a high quality look to the painted vehicle, with a low CG for improved track performance.

Turning now specifically to FIG. 9, a process is described for manufacturing and painting a toy vehicle, such as vehicle 100 or 100a. In this example, an electrostatic painting process is provided, even though the car body may be substantially plastic.

Specifically, in one example, a car body may be molded from ABS and a chassis may be die cast using a zinc alloy, for example. As shown in block 910, the molded body may be placed on a rack via a spindle used to hold the body for the painting process. Any suitable rack or holding system may be used to support the molded body during the painting process. In block 912, a base coat application of an electro-conductive solution (Basecoat I) is applied to the plastic body. In one example, the electroconductive solution used is a commercially available product with a trade name “Solad 20.” In one example, the solution may comprise the product and a solvent. Any suitable solvent may be used, such as, for example, isopropyl alcohol. For example, the electro-conductive solution may include Solad 20 and isopropyl alcohol.

After applying Basecoat I, in block 914, an air cure may be performed. In one example, it may be performed at room temperature, with still or motion air. Any other curing method may also be used.

Once sufficiently cured, then, in block 916, a topcoat application (Topcoat 1) of the desired paint may be applied. In one example, a RANSBURG robotic painting booth may be used. However, alternative paint application approaches may be used, if desired. In one example, Topcoat I may be a plastic lacquer.

Topcoat I may be positively charged such that it reacts with the negatively charged body (charged via the electro-conductive solution), or vice versa. The use of the charged solutions enables electro-static painting to be performed on the plastic body.

Next, in block 918, a cure is performed in an oven at approximately 70-80 degrees C. for approximately 20 minutes. Note that this may be varied depending on the type of paint used, the color of paint used, the size of the plastic body, humidity, and various other factors.

In some embodiments, a second layer may be applied to the vehicle body. For example, in block 920, a repeat application of the electro-conductive solution may be applied (Basecoat II). In block 922, another topcoat (Topcoat II) may be applied with clear acrylic lacquer. Again, positively charging the paint, and applying the positively charged paint to the negatively charged electrostatic layer on the body, may enable electro-static painting to be performed on the plastic body.

Again curing may occur. For example, in block 924, another oven cure may be performed at approximately 70-80 degrees C. for approximately 20 minutes. Again the time and/or temperature may be varied based on numerous factors. Finally, in block 926, the part is de-racked.

Bringing together various of the manufacturing processes described herein for manufacturing a scale vehicle, such as a toy vehicle, the following steps (alone or in combination with these or other step) may be used to generate a toy vehicle:
die cast a chassis;
laser etch a code onto a the chassis;
mold a plastic body;
paint plastic body via using an electroconductive solution (see FIG. 9);
co-mold wheels;
couple plastic body and chassis;
add shaft to chassis;
add wheel(s) to shaft; and
press ends of shaft to capture wheel(s) by forming a head.

As will be appreciated by one of ordinary skill in the art, the specific routines and/or processes described herein may represent one or more of any number of processing strategies. As such, various acts, steps, and/or functions illustrated may be performed in the sequence illustrated, in parallel, or in some cases omitted. Further, additional steps may be added. Likewise, the order of processing is not necessarily required to achieve the features and advantages, but is provided for ease of illustration and description. Although not explicitly illustrated, one or more of the illustrated acts, steps, or functions may be repeatedly performed depending on the particular strategy being used. Further, these figures may graphically represent code to be programmed into a computer readable storage medium in a controller used to control the manufacturing, etching, painting processes, and/or combinations thereof.

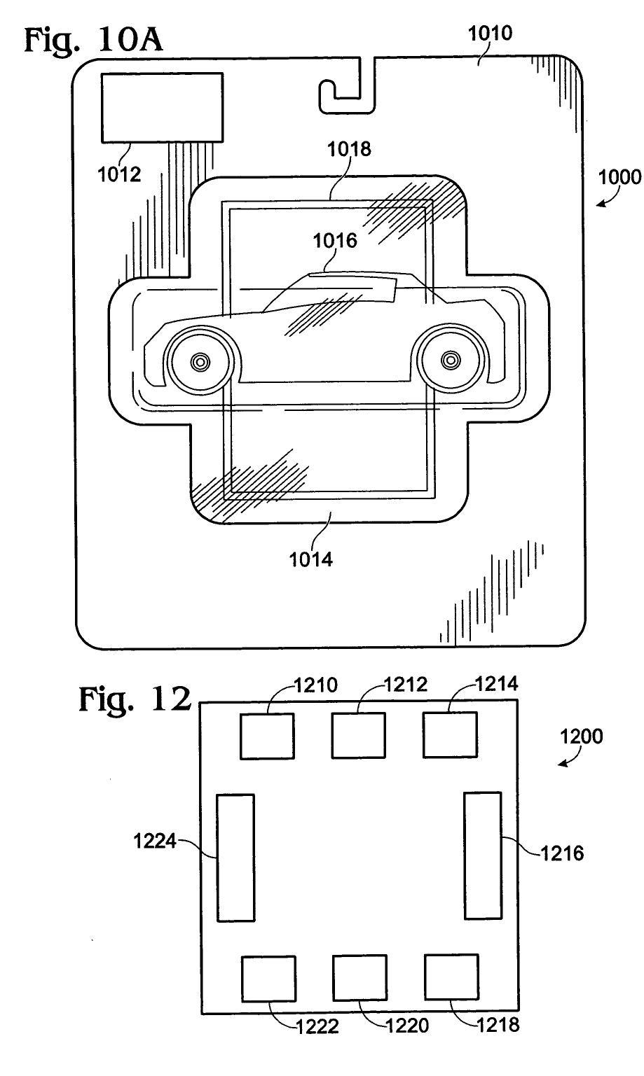

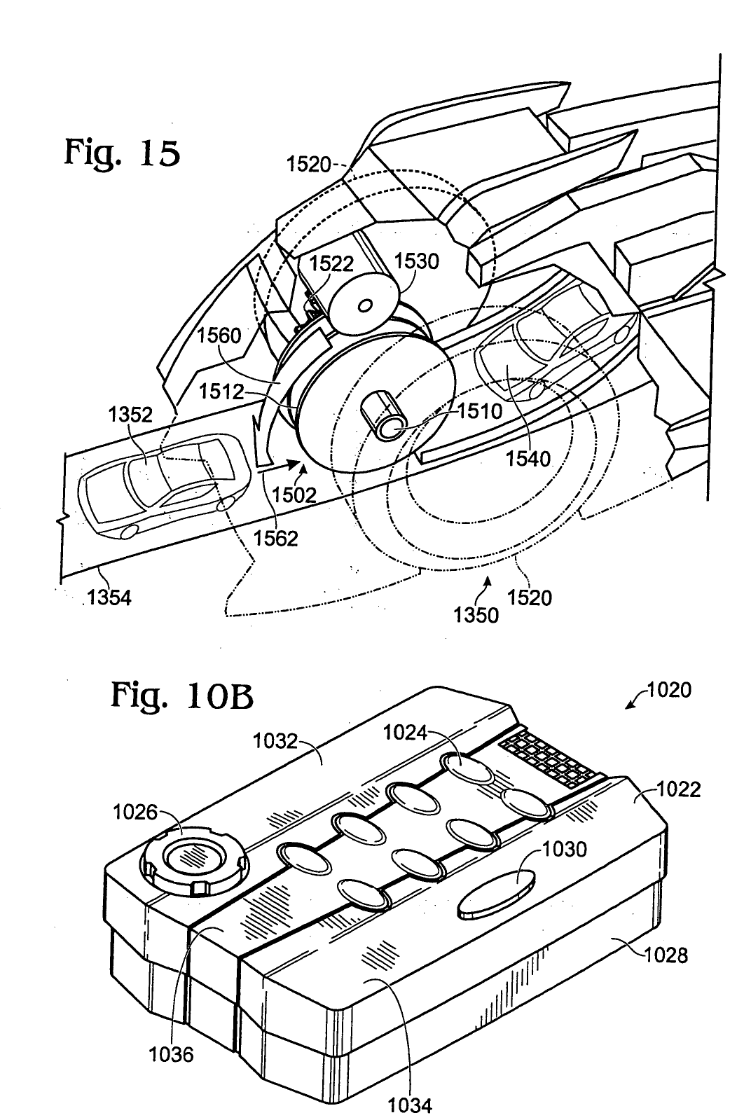

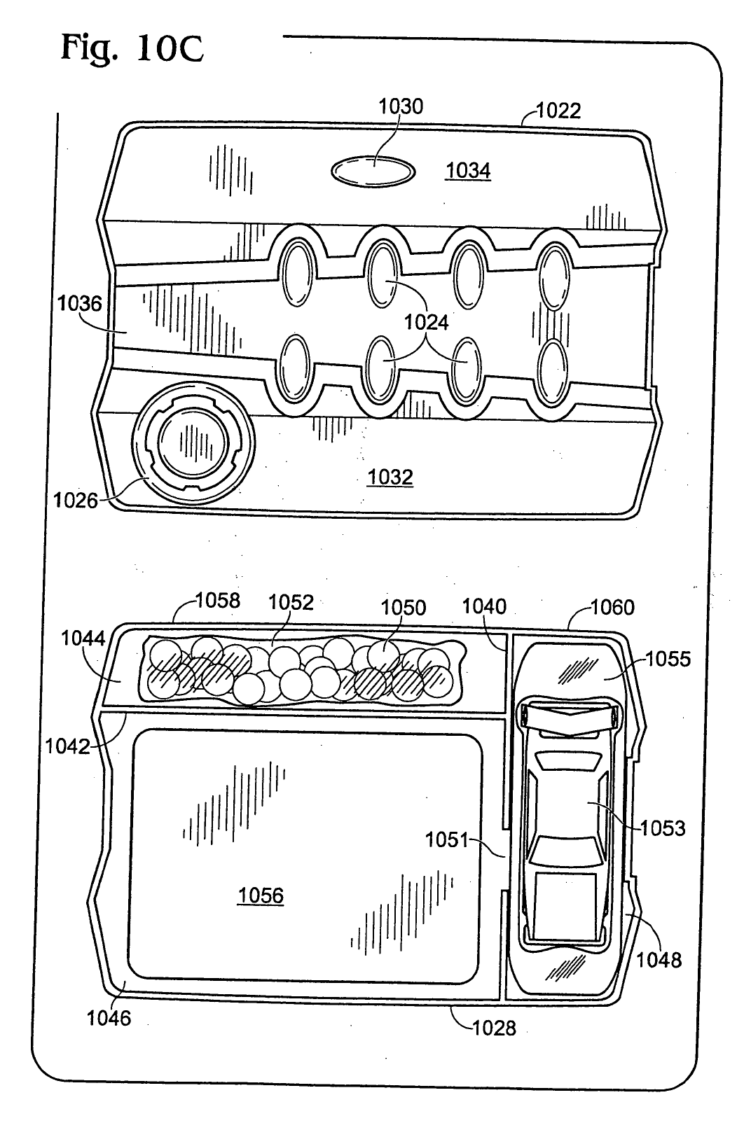

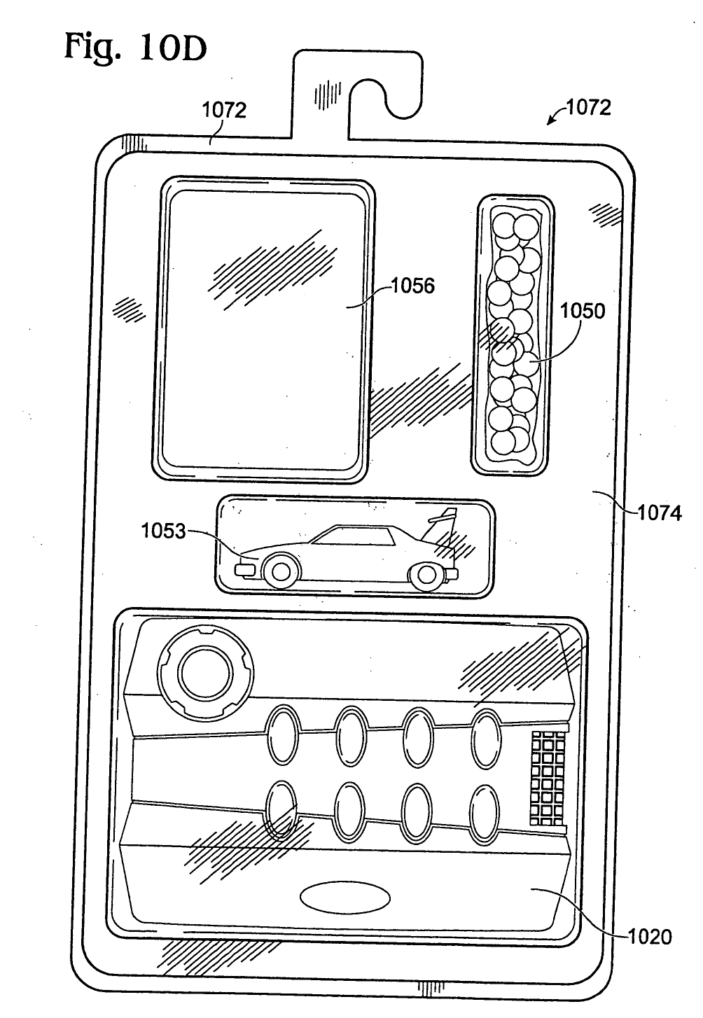

Referring now to FIG. 10A, an example package 1000 is described in which a car and one or more cards for a card game are packaged together for sale. Although described and discussed as “cards”, it should be appreciated that “cards” as used herein may include any type of game piece, including, but not limited to tokens, chips, player pieces, markers, etc. In one embodiment, cardboard backing 1010 may be used, where various marketing and other text and graphics may be applied, such as logo 1012. A blister pack 1014 may be applied to cardboard backing 1010 and held with an adhesive, or other connection substance, so that the blister pack is removable by a purchaser. As shown in FIG. 10A, blister pack 1014 holds a product, such as a toy vehicle 1016, and a package of cards 1018. Toy vehicle 1016 may include any of the features described herein, such as translucent or transparent wheels, and/or a laser etched code. Package of cards 1018 includes cards that may be used in an expandable deck card game, such as is described below. However, the cards may also be collectable cards, trading cards, lottery cards, informational cards, and/or cards for use in a card game, board game or electronic game.

In one example, package of cards 1018 is a sealed package of 3 separate cards. In some embodiments, the content of the cards may be at least partially concealed by at least one of the card package 1000, or vehicle 1016. In other embodiments, the content of the cards may be available for viewing through the package. Moreover, in alternative embodiments, more or less cards may be used. For example, a deck of cards, or multiple decks of cards may be included in package 1000. Also, the card(s) may be unpackaged, yet still captured by blister pack 1014.

In one embodiment, at least one of the cards in package of cards 1018 may used for a card game, such a fixed or expandable deck race car game that also relates to toy vehicle 1016. For example, the race car game may have cards that relate to vehicle 1016, even though the particular cards in 1018, or one of the cards in 1018, do not necessary relate to vehicle 1016. Alternatively, at least one of the cards in 1018 may specifically relate to vehicle 1016.

Referring now to FIGS. 10B-D, alternative packaging examples that may be used are shown, along with example containers and retail packaging.

Specifically, FIG. 10B shows an example container or case 1020 for holding cards for a card game, tokens, a toy product (such as a toy vehicle, figure, etc.), instructions, or combinations thereof. Further, additional game pieces, cards, etc. may also be stored in container 1020. In this example, container 1020 has shape aspects related to a game or product that may be stored in container 1020. For example, in the case of a card game related to vehicle racing, container 1020 may be configured to have a shape related to the vehicle or racing, such as an engine part. For example, container 1020 is shaped as any engine manifold. However, other shapes may also be used, including a wheel, tire, steering wheel, seat, accelerator or gas pedal, shift lever, trunk, turn signal, windshield wiper, cylinder, piston, radiator, combinations thereof, or others. Further, the container may have a shape related to a part typically included in products that relate to the game, which also applies to the case where the container is in the shape of an engine part typically included in a vehicle, such as the engine manifold.

Continuing with FIG. 10B, a top section 1022 is shown have a shape related to an engine. Specifically, intake manifold runners 1024 and oil cap 1026 are shown as example shapes related to racing vehicles. The top section 1022 may be removably coupled to lower section 1028. In one example, top section 1022 is configured to fit over lower section 1028, creating an interference fit to hold top section 1022 to the bottom section 1028. In another example, a clasp, lock, or other device may be used to couple the top and bottom sections. Returning to top section 1022, it may include two manifold cover sections 1032 and 1034, which may be of a rougher surface finish than manifold runner section 1036.

In one example, a raised section 1030 is used, which may be in the shape of a logo. Specifically, a raised section in the shape of a logo may be used on the product. The raised logo section may include additional marking or VUM to create contrast, if desired.

Container 1020 may comprise plastic or other materials, such as metal or cardboard. Further, it may be painted, such as by the paint process described herein in the example, where a plastic container is used.

Referring now to FIG. 10C, an example embodiment is illustrated where container 1020 is shown in an open position holding various items (showing the interior of the top and bottom sections). Specifically, top section is shown removed from bottom section 1028. In this example, bottom section 1028 may include tabs 1058 and 1060 to enable or improve removable coupling of the top and bottom sections.

Bottom section 1028 may also include a plurality of internal walls, such as wall 1040 and/or wall 1042. In this example, walls 1040 and 1042 create three container sections 1044, 1046, and 1048. Section 1044 may be used and/or configured to hold a set of tokens 1050 (which may be originally packaged in a clear plastic bag 1052 so that they are not lost). Section 1044 may be used and/or configured to hold a plurality of cards 1056 (such as two decks of 40 cards, or more, or less, which may be starter sets for an expandable deck card game). Section 1046 may be used and/or configured to hold a product related to the card game (such as a toy vehicle 1053, which may be secured in a plastic retainer 1055 so that any damage to the vehicle during movement may be reduced). In one example, retainer 1055 is shaped to receive vehicle 1053 and securely hold vehicle 1053. Also, wall 1040 may comprise a cut-out section 1051 so that a user may more easily remove one or more cards 1056.

Also note that additional wall and/or container sections may be used to hold other items, such as additional cards, other products such as dolls, figures, etc., or other collectible items.

Turning now to FIG. 10D, an example package 1070 is shown, where the package may comprise a container 1020, toy vehicle 1053, tokens 1040, and cards 1056. In one embodiment, cardboard backing 1072 may be used, where various marketing and other text and graphics may be applied, such as a logo. A blister pack 1074 may be applied to cardboard backing 1072 and held with an adhesive or other connection substance, so that the blister pack is removable by a purchaser. Alternative, a separate blister pack may be applied to each item, or sub-groups of items, if desired. As shown in FIG. 10D, blister pack 1074 holds one or more products, such as a toy vehicle 1053, package of cards 1056, tokens 1050, and/or container 1020.

Toy vehicle 1053 may include any of the features described herein, such as translucent or transparent wheels, and/or a laser etched code. Further, the vehicle may have special markings different from the case where the vehicle is sold separately from the game and container. For example, vehicle 1053 may have a body with translucent and/or transparent sections, and/or wheels with translucent aspects, such as described herein, for example. Thus, in one example, the special decoration of the vehicle included may be its translucent body, which enables viewing of internal components, such as speakers.

As noted above, package of cards 1056 may include cards that may be used in an expandable deck card game, such as is described below. However, the cards may also be collectable cards, trading cards, lottery cards, informational cards, and/or cards for use in a card game, board game or electronic game.

In one example, package of cards 1056 includes two separately sealed packages of 40 separate cards. In some embodiments, the content of the cards may be at least partially concealed. In other embodiments, the content of the cards may be available for viewing through the package. Moreover, in alternative embodiments, more or less cards may be used. For example, a single card may be used. Also, the card(s) may be unpackaged, yet still captured by blister pack 1074.

In one embodiment, at least one of the cards in package of cards 1056 may used for a card game, such a fixed or expandable deck race car game that also relates to toy vehicle 1053. For example, the race car game may have cards that relate to vehicle 1053, even though the particular cards in 1056, or one of the cards in 1056, do not necessary relate to vehicle 1053. Alternatively, at least one of the cards in 1056 specifically relates to vehicle 1053.

In still another embodiment, container 1020 has a shape that relates to vehicle 1053 and/or to the content of cards 1056, or the game using cards 1056. Further, instructions may be included and may or may not be visible through blister pack 1074.

In one example, container 1020 hold two decks of cards for an expandable card racing game, as is described below herein.

In an alternative embodiment, the container, vehicle, tokens, cards, and/or instructions may be packaged with the container in the closed position, and the components held within the container, and a clear wrapping around the container (as opposed to the “packed-out” package of FIG. 10D).

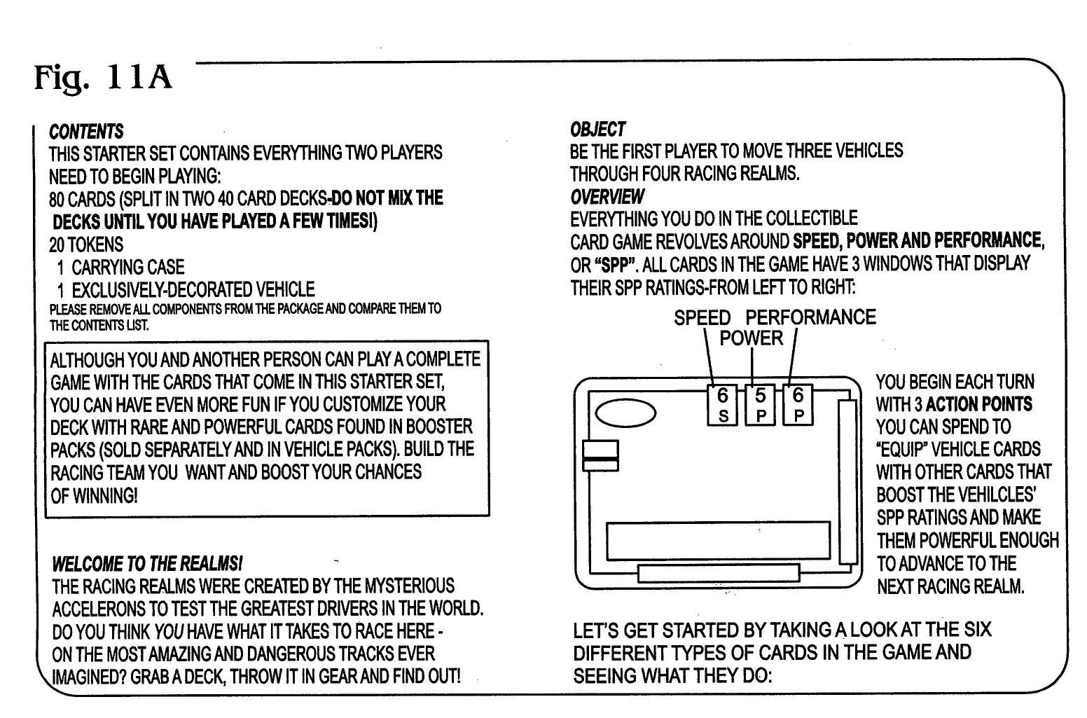

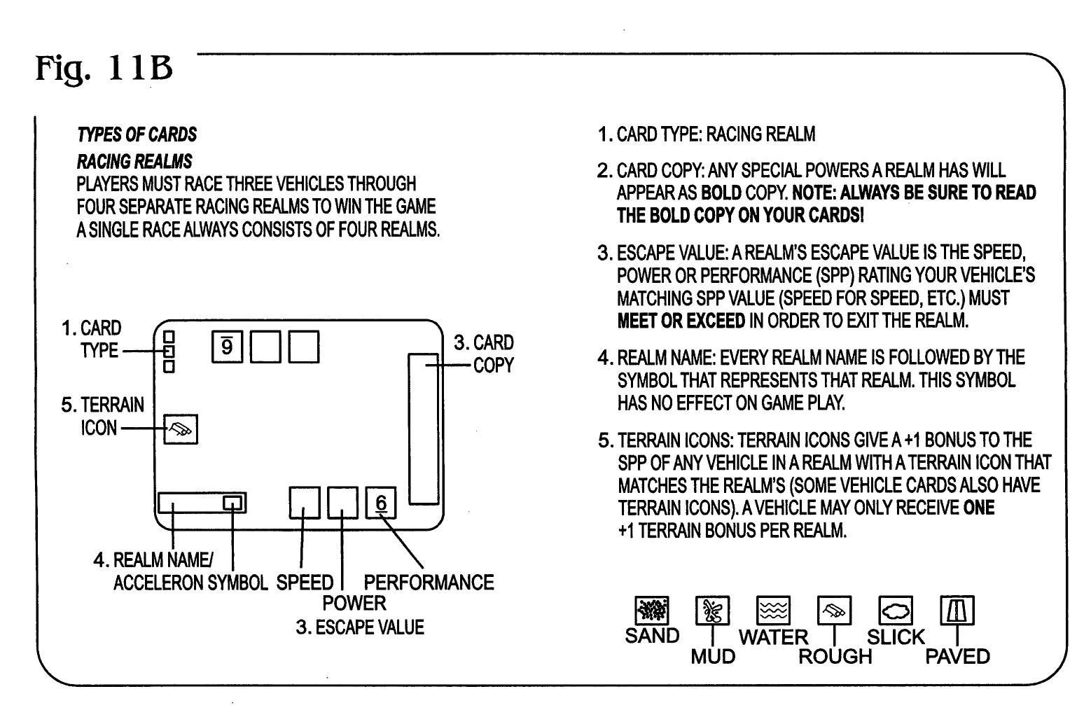

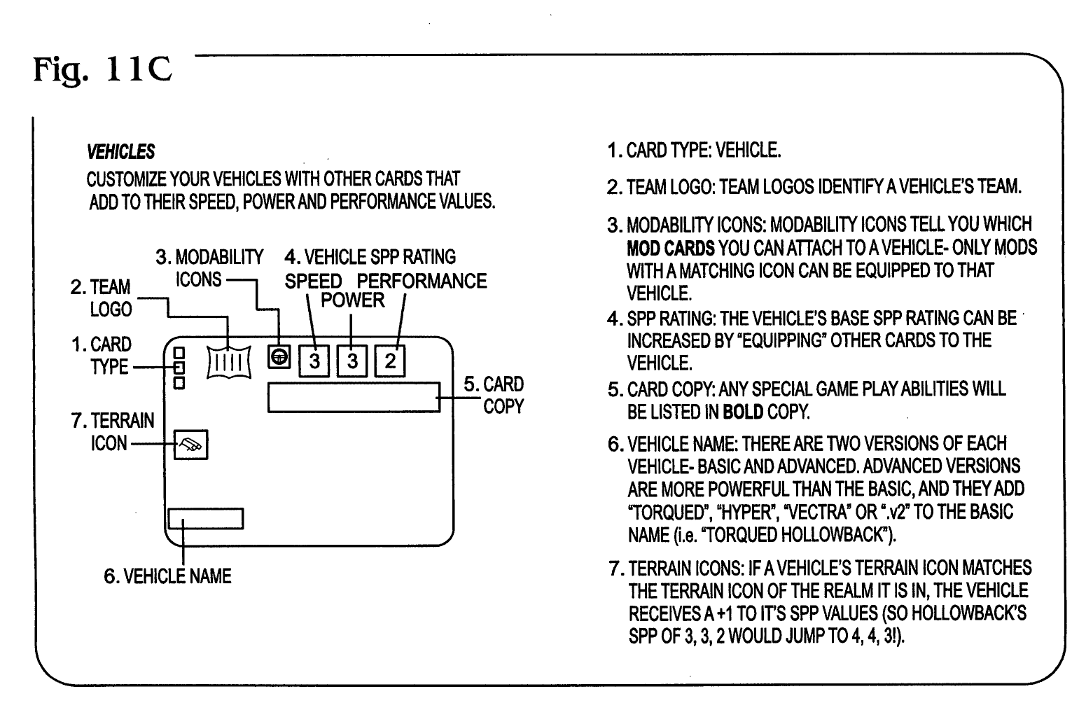

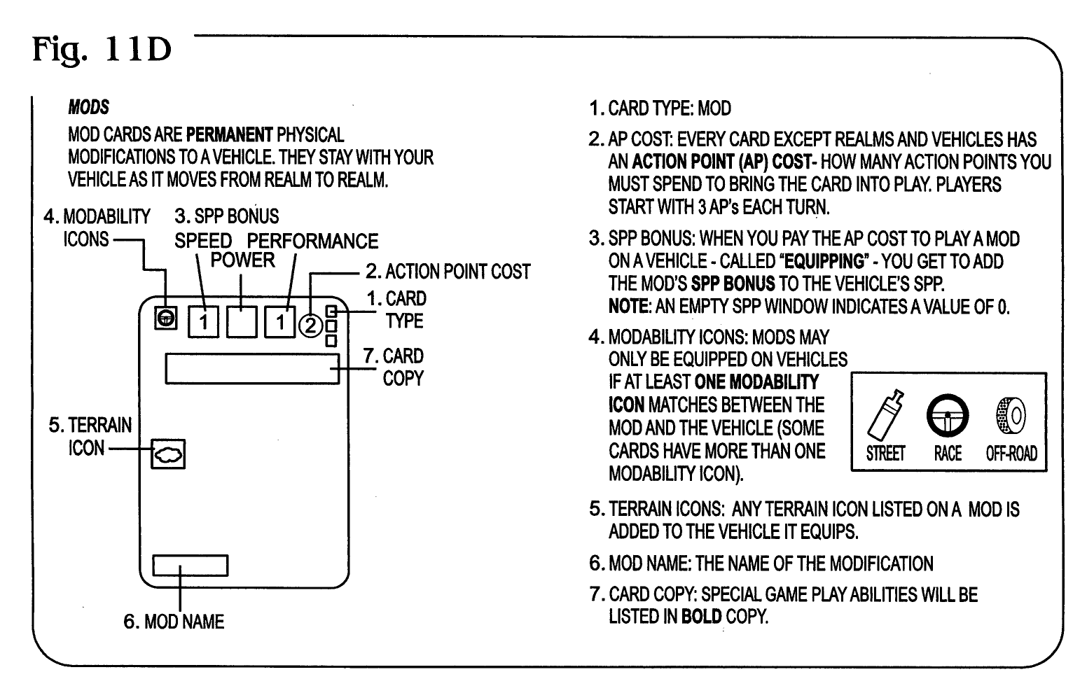

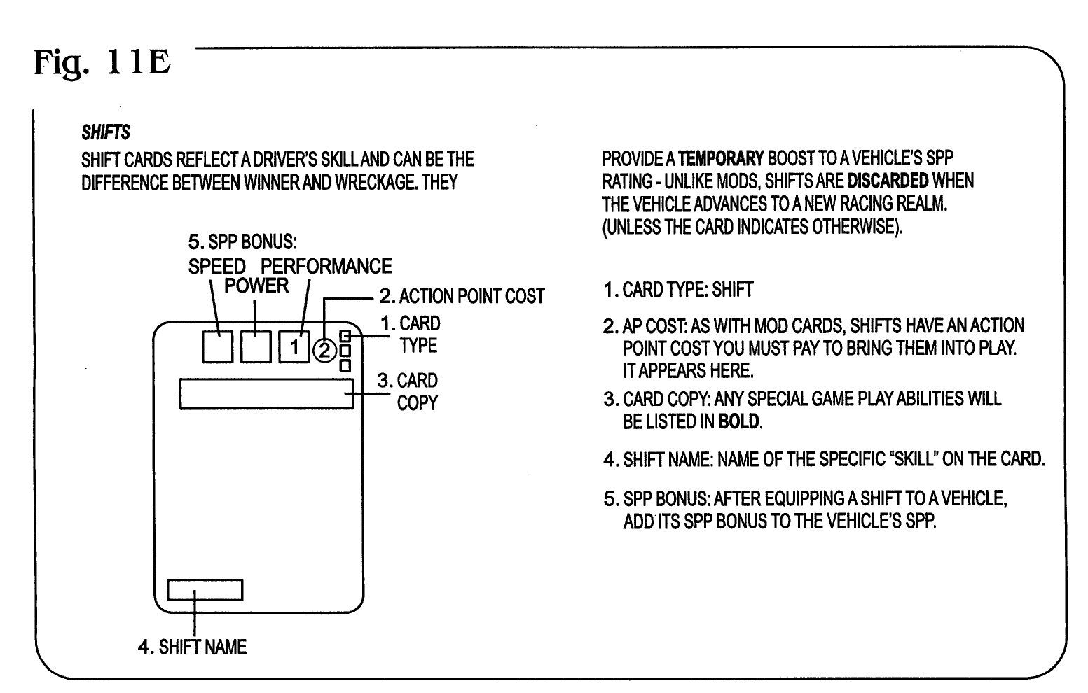

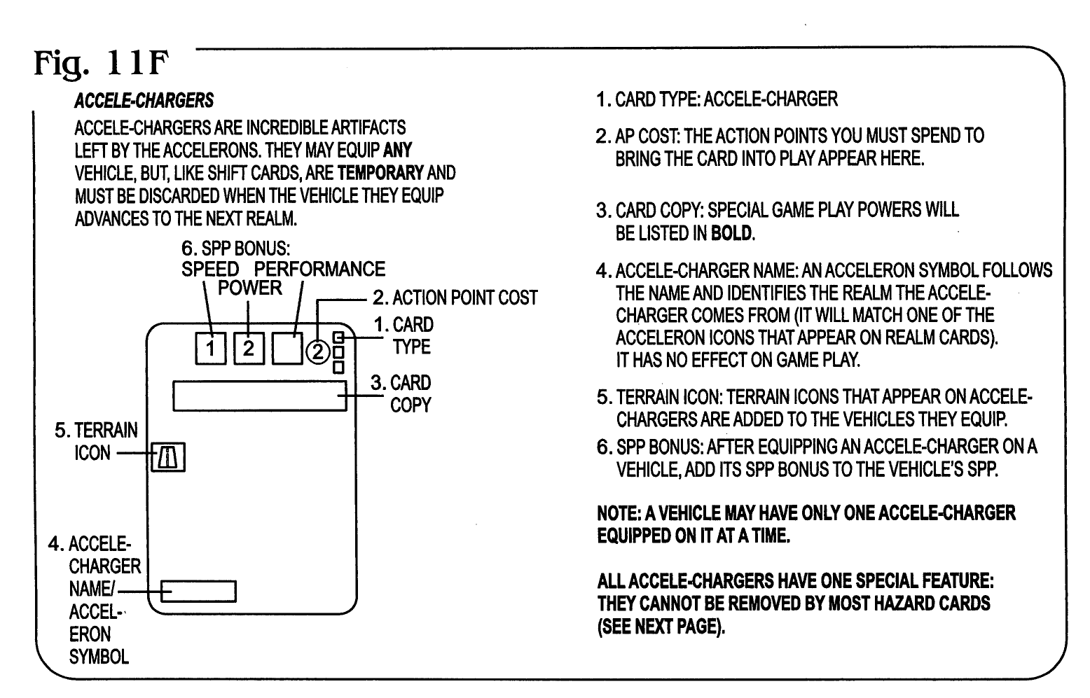

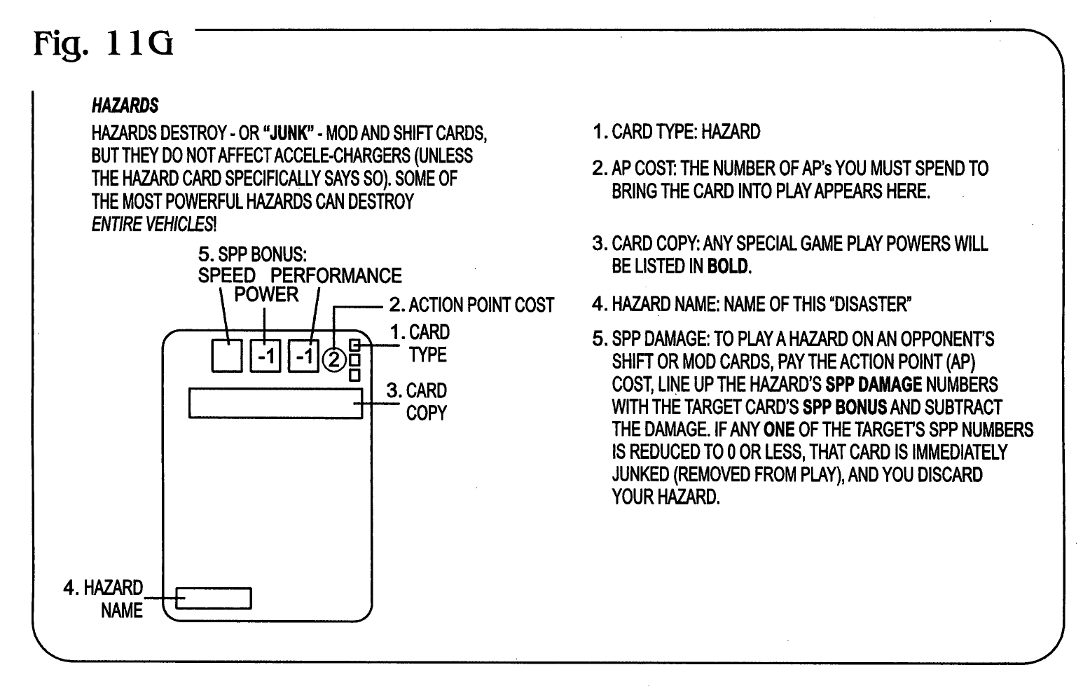

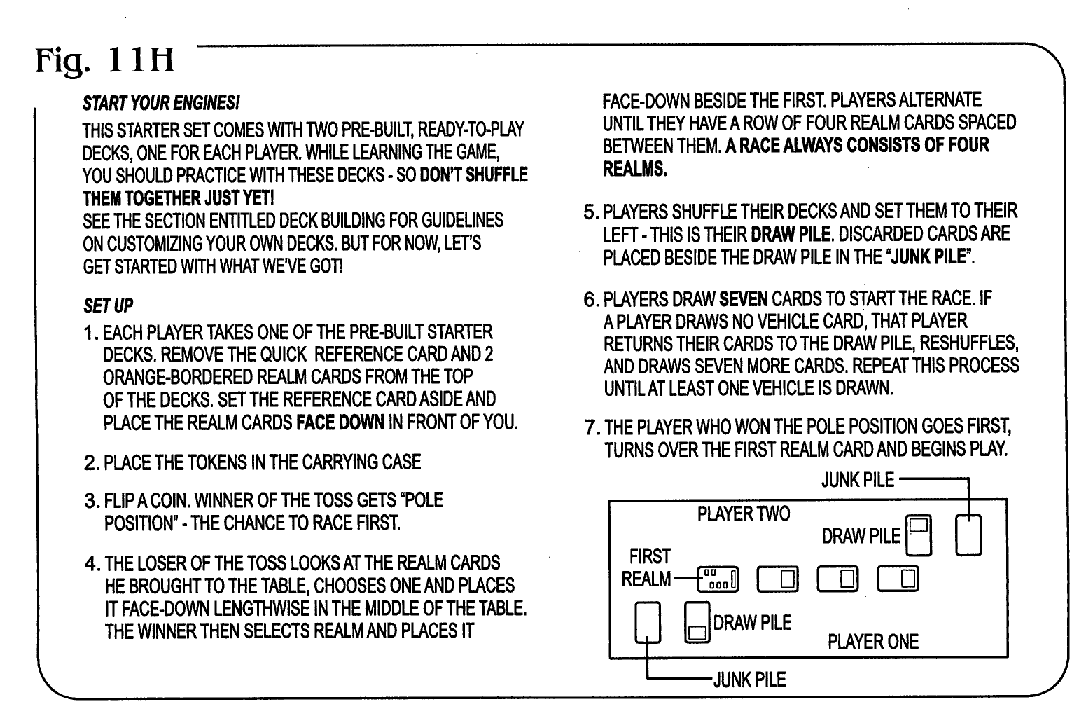

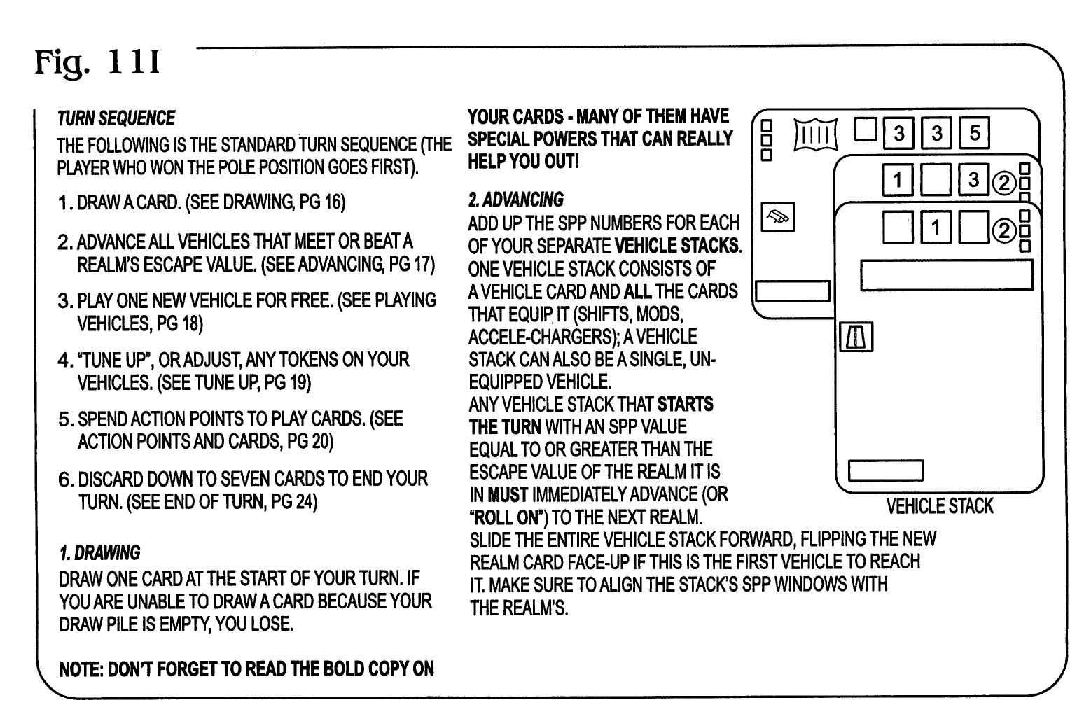

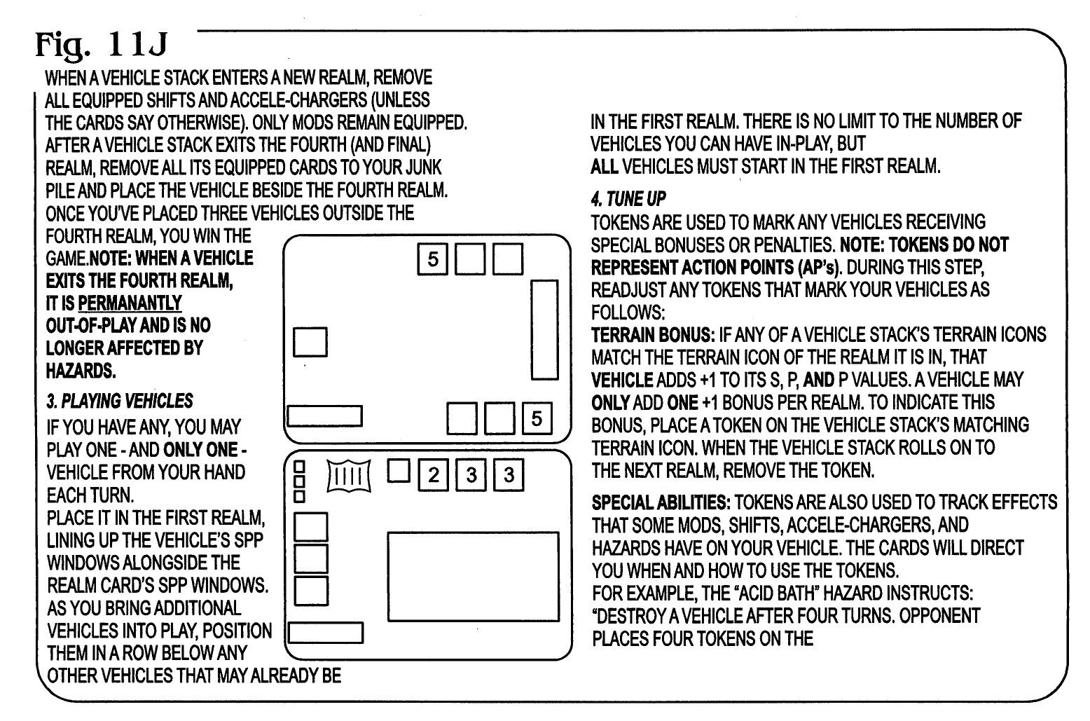

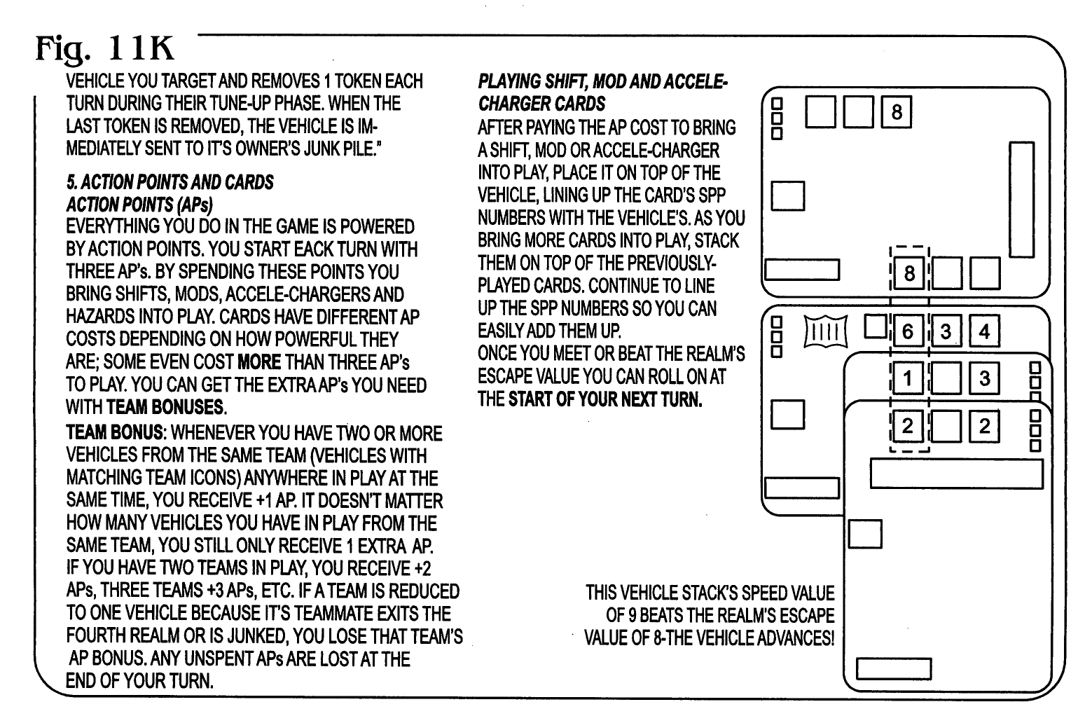

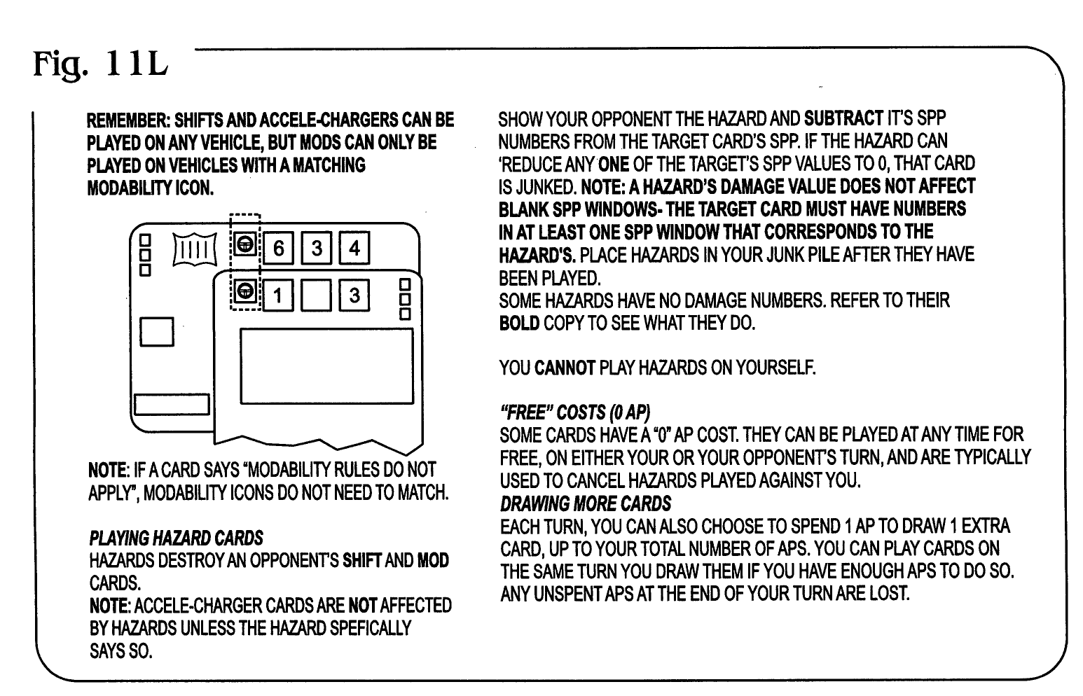

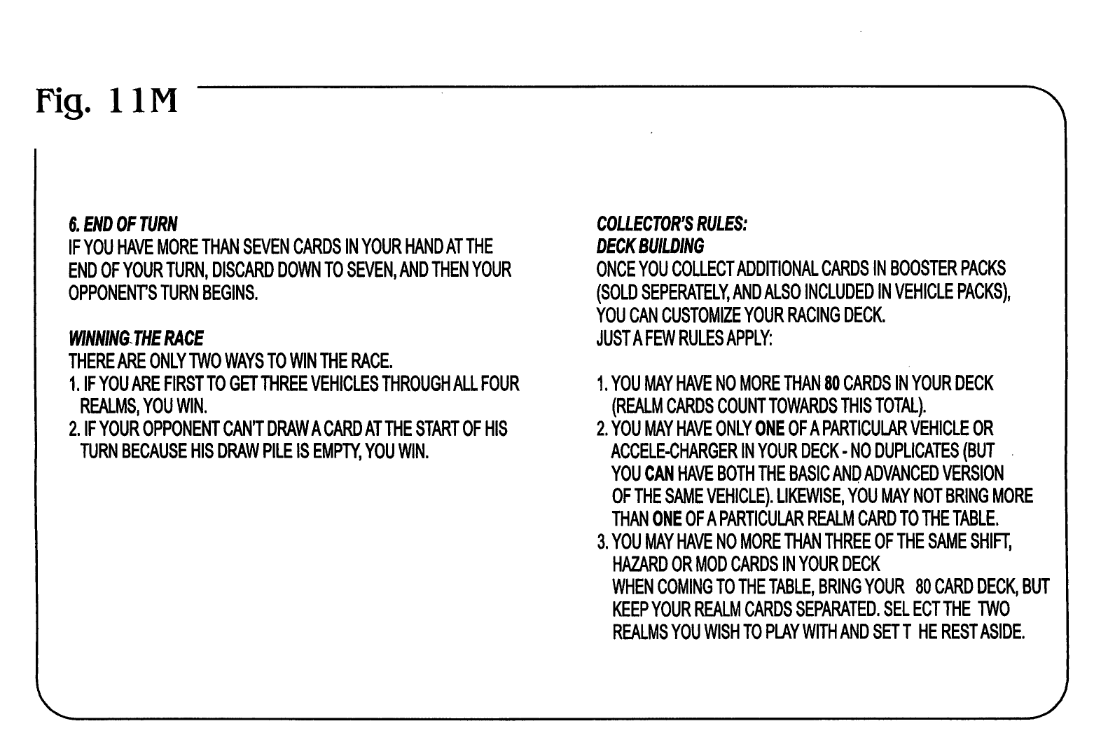

An example card game that at least one of cards 1018 and/or 1056 may be used in is described below. An alternative embodiment is shown via the instructions illustrated with regard to FIGS. 11A-N. Note that these are just examples, and various other card games may be used. For example, the card game may be related to figures or dolls, for example.

In one example, a card game playable by two or more players is disclosed, where in one embodiment, the card game includes one or more card decks. Each deck may comprise a plurality of game cards. The game cards may be divided into numerous categories. A first category of cards may be used to identify and/or build a card game path. A second category of cards may be used to represent objects intended to travel along the card game path. A third category of cards may be used to modify or otherwise alter the objects traveling the card game path. A fourth category of cards may be used to thwart the efforts of a playing opponent. Each of these categories of cards may be further subdivided into subcategories differentiated by a number of factors including, but not limited to, when or how the cards are played during the card game. Note that cards from any of the above categories may be included in the package of cards 1018 sold in package 1000 discussed above.

In one embodiment, players compete to be the first to successfully maneuver objects along the entirety of the card game path. As an example, the card game may take the form of a racing car game as shown in FIG. 11. In this example, the card decks may comprise a plurality of cards including realm cards, vehicle cards, mod cards, shift cards, Accele-chargers cards and hazard cards. The realm cards may be used to set up the racetrack, across which players will compete to race their vehicle cards. Players' vehicles may be modified or otherwise altered by mod cards, shift cards, and Accele-chargers cards. Players may attempt to thwart the efforts of their opponents by using hazard cards.

According to the presently described example, realm cards may provide various types of information including speed, power, or performance numbers and one or more terrain modifier indicators, the functions of which will be explained in further detail below. Realm cards may further include an area for the name of the card and an area for miscellaneous information that may include additional card game rules or information related to the world in which the card game is based. The card may further include a picture or other decorative item. In one example, a realm may be a racing realm, such as a fantastic track set in an environment that will test some aspect of a vehicle's abilities. Each realm may have a speed, power or performance expectation in addition to some terrain modifier.

Vehicle cards may include speed, power, or performance numbers and a terrain modifier indicator. Vehicle cards may further include a mod compatibility indicator, team logo, and an area for the name of the card, an area for miscellaneous information, and a picture or other decorative item. In one embodiment, the vehicle may be selected from 4 race teams, each having a unique overall attribute in regard to their speed, power, performance and ability to be modified. Vehicles may also have an added terrain modifier benefit.

Modification, or mod, cards may include speed, power, or performance numbers and a terrain modifier indicator. Mod cards may further include an area for the card name, an area for miscellaneous information, and a picture or other decorative item. The modifications may stay with vehicles from realm to realm. Alternatively, the modification may be temporary.

Shift cards may include speed, power, or performance numbers. Shift cards may further include an area for the card name, an area for miscellaneous information, and a picture or other decorative item. For example, a shift may be commendable aspects of a drivers abilities, such as a positive modifier towards a vehicles speed, power or performance.

Accele-chargers cards may include speed, power, or performance numbers. Accele-chargers cards may further include an area for the card name, an area for miscellaneous information, and a picture or other decorative item. The benefit of Accele-chargers cards may be only temporary in the card game, such as for a fixed number of plays.

Hazard cards may include speed, power, or performance numbers. Hazard cards may further include an area for the card name, an area for miscellaneous information, and a picture or other decorative item. Hazard cards may be negatively impact a vehicle speed, power or performance, destroy a car, strip it of mods, etc.

The card game may further include a plurality of tokens that may be used to indicate various occurrences in the card game. Specific exemplary uses of the tokens are discussed below.

According to one method of play, the players typically try to win the card game by moving a predetermined number of vehicles through a predetermined number of realms. A vehicle is considered to have “passed through” or “successfully traversed” a realm when the vehicle's speed, power and performance values meet or exceed those posted on the realm card.

Each vehicle begins the card game with base speed, power, and performance values. These base values are typically printed or otherwise indicated on the card. The base values of the vehicle can be altered, either increased or decreased, by playing mod, Accele-chargers, shift, or hazard cards. Once a vehicle's speed, power, and performance values meet or exceed the realm's speed, power, and performance values, the realm is considered to have been traversed and the vehicle moves on to the next realm.

Each player may play with their own deck of cards that includes a combination of realm, vehicle, Accele-chargers, mod, shift, and/or hazard cards. The number of cards in a deck may be limited to a certain number of cards, i.e. forty. Alternatively, a deck may include more or fewer than forty cards.

The card game may be packaged ready to play in the form of two forty card pre-built decks. Alternatively or additionally, cards may be available for individual purchase (singly or in groups) so that players may create their own unique decks by combining some or all of a pre-built deck with individually purchased cards (or another pre-built deck) or combining numerous individually purchased cards. For example, as noted above, one or more or groups of cards may be packed with a toy, such as a toy vehicle as described with regard to FIG. 10A above. For example, in the presently disclosed embodiment, while players may have six different card types from which to build their decks, each deck may include varied numbers of each type of card. Any number and type of such cards may be provided with the vehicle.

For exemplary purposes, the following play instructions are provided for the example card game. It should be appreciated that other instructions may be provided and that such instructions may be varied without departing from the scope fo the disclosure. Further other card games may be provided and included with the toy vehicle.

Initially, each player removes three realm cards from his or her deck. The players then alternate setting the realm cards out in a line. For example, a total of six realm cards may be laid out to form a racetrack. Player A places one of her realm cards (realm A1) face down on the table. Player B then places one of his realm cards (realm B1) face down on the table next to realm A1. Player A then places another realm card (realm A2) face down next to realm B1, and so on, until all six realm cards are laid out in a single linear line.

After placing their realm cards on the table, the players each shuffle their decks and draw a given number of cards to form an initial hand. For example, each player may initially draw seven cards. However, it will be appreciated that a hand may be comprised of more or less than seven cards.

Players then take turns drawing cards and placing cards on the table according to the rules of the game. According to the presently described method of playing the game, each player is given a certain number of action points at the beginning of each turn. Typically, players begin with the same number of actions points, for example, 3. However, as explained in further detail below, the number of action points available to a player may be altered by various events and circumstances during the play of the game. Action points may be represented by a physical token or other item. However, in many cases players may be able to remember the number of action points available to them without the use of a token, and therefore it may not be necessary to provide one.

During a turn, a player may draw a card and then place any cards in his or her hand on the table so long as the player has enough available action points in order to play the cards. For example, vehicle cards typically require no points and may, therefore, be placed on the table without reducing the number of action points available to the player. In contrast, shift, mod, Accele-chargers, and hazard cards typically each have a specific action point value. A player may play one or more of these cards so long as the number of action points the player has available is higher than or equal to the total number of action points required by the cards.

For example, player A may begin her turn with 3 action points available. In player A's hand is a vehicle card (which requires no action points), a 2 point mod card, a 3 point mod card, a 4 point mod card, a 1 point hazard card, a 1 point shift card, and a 2 point Accele-chargers card. Player A can play her vehicle card, which requires no action points, and any combination of the other cards in her hands so long as the cards' total action point requirement is less than or equal to 3. Therefore, player A may chose to play the 2 point mod card and the 1 point shift card, or only the 3 point mod card. Player A cannot play the 4 point mod card or the 2 point mod card with the 2 point Accele-chargers card.

The rules may further limit the number or type of card that may be played during a turn. For example, while vehicle cards may not require any action points to be played, players may be limited to introducing only one vehicle card per turn into the game.

Furthermore, the rules may provide for methods by which a player may increase the number of action points available at the beginning of his or her turn. For example, each vehicle may include a team logo indicating that the vehicle belongs to a particular team, and a player may be awarded an additional action point if the player has two or more vehicles from the same team “in play,” i.e., placed on the table.

As stated above, the game may be played by 2 or more players. Card decks may also be made available as starter sets. A starter set typically comes with two 40 card decks that are “prebuilt”. This means that the same cards will always appear in every starter set, they are not random.

The objective of the game may be to be the first player to race 3 cars through a series of racing realms. Typically, players alternate setting out in a line 3 racing realms each. As vehicles come into play, players will equip them to meet or beat the speed, power or performance expectation of each racing realm. Vehicles will be “equipped” with mod, shift or Accele-chargers cards. A player can thwart another by playing hazard cards; which blow off these enhancements or the vehicles themselves.

As noted above, the card game may be packaged with two decks of 40 cards packed out in clear wrap, a vehicle with unique starter set decorations, 12 wheel of power tokens (which may be plastic or paper), and instructions. In order to set up the game players may be asked to punch out 12 racing wheel tokens from the token card, or they may be contained in a plastic bag. In one example, such as the example of FIG. 10B, a card game (such as described herein) may be included with a toy product (that relates to the game, such as a vehicle for a card racing game) in packaging, where the packaging has an appearance related to the card game and/or the product. As described above with regard to FIG. 10B, the appearance may be of an engine, intake and/or exhaust manifold, wheel, tire, car, steering wheel, wheel hub, and/or combinations thereof.

According to one method of initially playing the game, each player takes one pre-built 40 card deck. Because the decks are pre-built, the players may be encouraged not to shuffle the decks together. Each player may remove the 3 racing realm card from each of their decks. Players may then take turns setting up the racing realms face down in a line between them. Each player may shuffle the remainder of their decks and places it in front of them, drawing seven cards. Alternatively, players may be allowed to draw cards until they obtain a vehicle card. Additional cards may then be drawn at the cost of an available action point per card. A maximum and or minimum card limit may be set. Thus, a player who had to draw ten cards in order to draw a vehicle card may be required to discard down to seven cards after playing the vehicle card.

At the start of each turn, players can draw a card, advance any number of vehicles that have met the expectation speed, power or performance value of the racing realm its in, and put into play a vehicle card for no cost, if desired. According to some methods of playing the game, players may be required to use one action point per card in order to draw cards.

As stated above, some of the racing realms may have a terrain modifier that provides a benefit to certain vehicles (such as increased speed, power, and/or performance values or additional abilities outlined on the cards or by the rules). In order to identify those vehicles that are currently benefiting from the terrain modifier in the current realm, players may place wheel of power tokens on vehicles that may have entered racing realms that allow them to use as terrain modifier. A player then has 3 Action Points (AP) to play out their turn. The number of action points available to a player during a turn may be increased by 1 AP for every Team of vehicles you have in play. For example, if a player has two racers from one team and two racers from another team in play, that player will now have 5 AP available for use.

According to one exemplary embodiment of the game, the number of AP needed to play each card may be determined by the card type, for example, Accele-chargers cards and hazard cards may require 3 points, mods 2 points, and shifts 1 point. Alternatively, AP point requirements may be varied along card types, i.e. different Accele-chargers cards may have different AP point requirements.

The ability to play a card may be dictated by its AP requirements, compatibility of a mod, card copy and/or the effects of a hazard card played against the opponent.

According to one method of playing the game, the first player to exit their third vehicle out of the 6th racing realm is the winner. If a player runs out of cards from their draw pile, the game stops and the winner maybe determined by a hierarchical list of attributes such as, the player furthest along the race track, the player with the most powerful vehicles, the player with the most equipped vehicles, etc.

The Racing Realm cards are initially put into play face down. Cards are laid out horizontally, end to end, separating the two players. This forms the “race track”. Each realm is named and has its own color palette. There may be supporting copy on the card that defines any associated game play. If a realm bears a terrain modifier icon, any vehicle with a corresponding icon will receive a +1 to its Speed, Power and Performance values. Place a Wheel of Power token on that vehicle. Once that vehicle clears that realm the token is removed, unless the next realm has the same terrain modifier icon. Vehicles may progress to the next racing realm when their corresponding speed, power or performance value meets or beat the exit value of the realm.

Vehicle cards may be played horizontally. This allows vehicle info to still be read off to the left side while it is equipped with vertically played mods, shifts or Accele-chargers cards. Vehicle cards are broken down into 4 “teams” in this example. Every, or at least one, vehicle may have a speed, power and performance value associated to it based off its vehicle type and/or experience. More specialized vehicles may also have a terrain modifier icon. Vehicles can also be “modified”. Its ability to be enhanced with a mod may be determined by its mod bar. In one example, a player needs to have a corresponding icon/color on their mod cards in order for it to be “equipped”. Vehicle cards can be brought into play for free at the beginning of a players turn. Only one vehicle can be brought into play per each player's turn. If two vehicles are brought into play that are on the same team, that player receives an extra action point per turn. If a player has multiple teams of vehicles out, they may receive an additional Action Point. A maximum of 6 AP are allowed.

Typically, mods may or may not require AP's to bring in to play. Mods may be thought of as a physical enhancement to a vehicle. These cards may be put into play vertically, on top of a vehicle with a corresponding mod bar. Their speed, power and performance values are added to the vehicle they are played on. mods can also add a Terrain Modifier advantage to a vehicle as depicted with an icon. Mods stay equipped to a vehicle as they teleport from realm to realm. An exception to this would be any play copy such as: Nitrox Boost, S (Speed), P (Power), P (Performance) values are applied to your vehicle for 4 turns. You would place 4 Wheel of Power tokens on the vehicle and remove one per turn. When all tokens are removed, the mod must be unequipped.

Shift cards may or may not require AP points to bring into play. Shift cards may be thought of as a driver advantage, i.e. something a driver does with their vehicle to get them ahead in the race. Shift cards are put into play vertically and placed on any vehicle. Their S, P, P values are added to the vehicle they are played on. Terrain modifiers if depicted, are also “added” to the vehicles' abilities. Shifts do not stay equipped from realm to realm. Once a vehicle teleports to the next racing realm, “equipped” shift cards are removed to the discard pile.

Accele-chargers cards may or may not require AP's to bring in to play. These cards represent the power gained from winning previous races. They are left as rewards from the Accelerons. Accele-chargers cards are put into play vertically and placed on any vehicle. Their super S, P, P values are added to the vehicle they are played on. Terrain modifiers if depicted, are also “added” to the vehicles abilities. Accele-chargers cards do not stay equipped from realm to realm. Once a vehicle teleports to the next racing realm, “equipped” Accele-chargers cards are removed to the discard pile.

Hazards may or may not require AP's to bring in to play. They are typically used to thwart the advance of the other players through the racing realms. When a hazard is played, reading the copy for the action is important. Action to be taken may be as simple as comparing its negative values against the type of card it is attacking. For example: If the hazard card effects a mod and has −2 in its power value, and the mod has −2 in its power value or less, the other player must remove the attacked mod. The exception is if the other player has a 0 point shift card that can counter the hazard played. Powerful hazards may cause an entire vehicle with attached mods to be removed from play.

Exemplary cards that may be used to form play decks, along with other elements of the example card game, are listed and described in FIG. 11.

While the above description and the description in FIG. 11 may describe specific rules, various alternative embodiments may be used where one or more rules is changed. For example, in an alternative approach, a vehicle may have more than one Accele-charger equipped on it at a time, or Accele-chargers may be removed by hazard cards, or there may more than 2 ways to win the race, or more than two plays may be allowed to play, if desired.

Referring now to FIG. 12, an alternative embodiment card 1200 is described. In one example, card 1200 is one of a plurality of cards that is a part of a card game, and may be used in a card game. However, in some embodiments, card 1200 may be a trading card, a collectable card, an informational card, etc.

In one embodiment, card 1200 includes one or more of various values, symbols, clues, codes, or features, or combinations thereof, such as in one or more of boxes 1210, 1212, 1214, 1216, 1218, 1220, 1222, and 1224, or combinations thereof. The information in these boxes may be relevant to the card game or trading value, and may be related to a vehicle depicted on the card 1200. Further, the information in these boxes may be related to a toy, such as a toy vehicle, sold with the card.

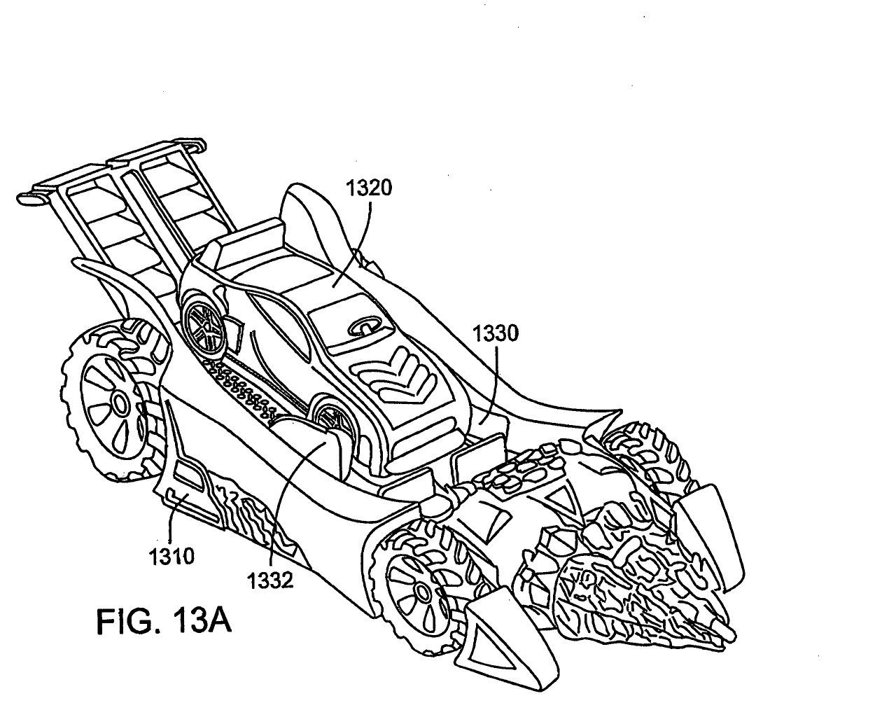

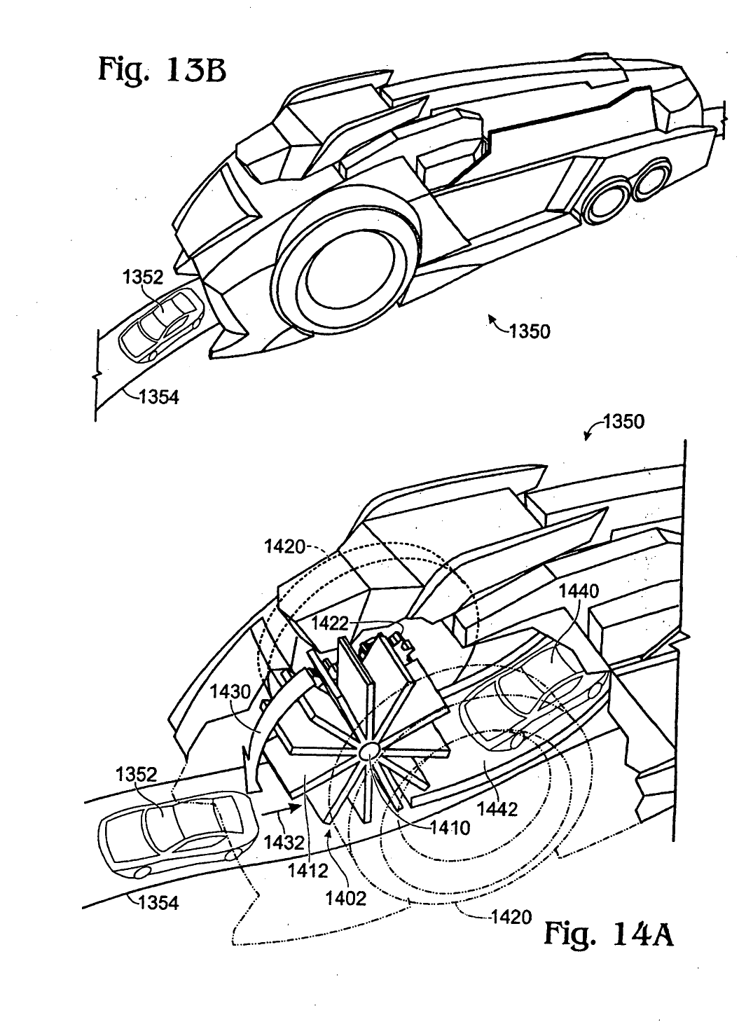

In addition to the vehicles described above, other types of vehicles may be provided which may be inter-related to the above items. For example, referring now to FIG. 13A, a carrier 1310 is described that is configured to receive a smaller vehicle 1320 (such as vehicle 100 or 100a) in a recess 1330. Further, carrier 1310 may be configured to interface with a track, as described in more detail below. In one example, a track and the carrier are each sized to cooperate so a car can travel from the track to the carrier vehicle.

While this example shows carrier 1310 as a vehicle having 4 wheels, it may be a stationary object, a toy gun, a landing pad, or an alternative vehicle, such as a truck, a car, a sports car, a station wagon, a sport utility vehicle, a dune buggy, a motorcycle, a unicycle, an 18-wheeler, a dump truck, earthmoving equipment, bicycles, tricycles, a rocket, a spaceship, a fantasy vehicle, or any other suitable vehicle.

In one example, recess 1330 is configured to be positionable at an end of a racetrack so that vehicle 1320 may be able to travel from the track to, and held in, recess 1330. Also, recess 1330 may include a connection member, such as clip 1332 to removeably couple vehicle 1320 to carrier 1310. Other connection members may be used, or no connection member may be used.

In some embodiments, carrier 1310 may have an activation switch (not shown), which may be coupled to recess 1330, that is engaged when vehicle 1320 is properly located in recess 1330. The switch can enable various functions performed by carrier 1310, such as automatic movement, enablement of a trigger, combinations thereof, or others.

In one example, vehicle 1320 may include various ones of the features described above, such as translucent or transparent wheel aspects, a code (such as a laser etched code), or be sold with one or more cards. Alternatively, carrier 1310 may include various ones of the features described above, such as translucent or transparent wheel aspects, a code (such as a laser etched code), or be sold with one or more cards.

In another example, carrier 1310 may be a vehicle that corresponds to a character on a television show, website, game, etc. For example, carrier 1310 may correspond to a character that modifies the functionality of a vehicle is a racing game or show, or mod in the card game discussed above.

Referring now to FIG. 13B, an example carrier 1350 for use with a smaller vehicle 1352 is shown. In one example carrier 1350 may have a body configured to be coupled to a track 1354. For example, in one example track 1354 may lead a vehicle (such as 1352) to carrier 1350 and terminate adjacent to carrier 1350. For example, carrier 1350 may be at a beginning or end of a track segment. In another example, carrier 1350 may be configured to move along track 1354, as shown in FIG. 13B. In still another example, carrier 1350 may be operatively coupled to a track. For example, the wheels and/or body of carrier 1350 may be configured so that carrier 1350 may move atop and along track 1354, by having a recessed bottom area that is configured to enable carrier 1350 to remain coupled to the ground while moving along track 1354. Alternatively, carrier 1350 may be configured to be removably coupled to track 1354 (e.g., by internal wheels or clips). In this way, in the case where carrier 1350 can collect and disperse items (such as vehicle 1352), carrier 1350 may collect and/or disperse items (such as vehicle 1352) from and/or onto track 1354. These features, alone or in combination may increase play and excitement for users of a vehicle track set, for example.

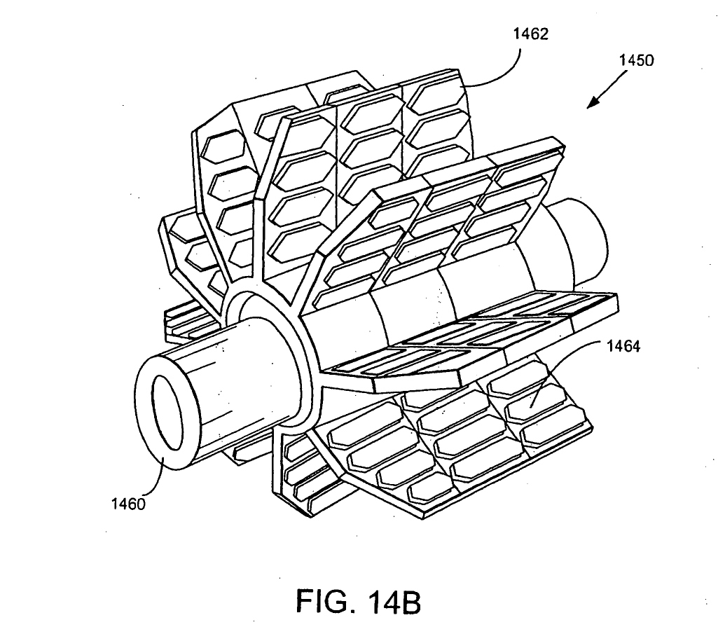

Referring now to FIG. 14A, a cut-away view of an example internal mechanism of carrier 1350 is shown having a collection and/or release device 1402. Specifically, an inner cylinder 1410 has a plurality of paddles 1412 extending radially from cylinder 1410, where the paddles may be rubber. While this figure shows 12 rubber paddles, more or less may be used. For example, in one example, 2, 3, 4, 5, 6, 7, 8, 9, 10, 13, 14, 15, or 16 paddles may be used, depending on the size and/or weight of the item being collected and/or dispersed, or other factors. Also, while Figure shows paddle 1412 being substantially rectangular, in an alternative example paddle 1412 may be triangular shapes, trapezoidal shaped, curved, and/or combinations thereof. The thickness of the paddles may be varied, and in one example, may be varied to vary the pliability of the paddles and thereby adjust their performance. In one example, the surface of the paddles may be smooth, while in another example raised sections may be used to increase friction between the paddles and an item to be collected/dispersed. Also some paddles may have a first feature or shape, while other paddles have a different feature or shape. Further, some of the paddles (e.g., a first paddle) may be of different size (e.g., shorter, narrower, thinner) than other paddles (e.g., a second paddle).

While this example shows paddles comprising rubber, various other materials may be used in the alternative of, or in addition to, rubber. For example, plastics or metals may be used, or plastic covered foam may be used.

Also, in one example, additional inertia, such as in the form of a metal disk mounted to one side of the paddles (e.g., so as to avoid contacting an item during collection and/or dispersion) may be used. Alternatively, additional inertia may be placed in cylinder 1410, if desired.

Continuing with FIG. 14A, in this example mechanism 1402 may be powered by motion of carrier 1350. Specifically, either or both of wheels 1420 may be coupled to device 1402, directly or through a gear mechanism 1422, to rotate cylinder and paddles 1410 and 1412 via rotation of the wheel(s).

For example, when a user pushes carrier 1350 along a surface, motion may be transferred to rotate paddles 1412 in one direction, or another, so that a vehicle 1352 positioned along the path (which may be a track 1354) may be collected (following arrows 1430 and 1432 of FIG. 14A) and moved to the position of vehicle 1440 along an internal track 1442. In one example, internal track 1442 may be configured to rest on track 1354, or the surface on which carrier 1350 is positioned. Alternatively, internal track 1442 may be configured to be operatively connected with an end of track 1354.

Internal track 1442 may also include a separator to separate collected vehicles along one or more paths. The separator may be a separate plate that alternates between alternative positions to direct collected vehicles along a specified path to a specified location. In another example, the separator may be a magnet that attracts metal components of collected vehicles along a specified path to a specified location. Further still, the separator may be angled track section that allow collected vehicles to move along one path or another with a somewhat random pattern, depending on how the vehicle was collected, its collection speed, its weight, and/or various other factors.

In addition to collection action, opposite action can also be performed. For example, a user may push carrier 1350 along a surface creating motion which may cause a vehicle stored in carrier 1350 (e.g., a vehicle in a position of vehicle 1440) to be dispersed or released (following a direction opposite to 1430 and 1432). For example, carrier 1350 may be free-wheeling, in one example.

In one example, when carrier 1350 is moved in a first direction, paddle 1412 rotates in a first direction, and when carrier 1350 is moved in a second direction, paddle 1412 rotates in a second direction. For example, when carrier 1350 moves forward, an item in its path may be collected, and when carrier 1350 moves backward, an item stored in carrier 1350 may be dispersed. Alternatively, when carrier 1350 moves backward, an item in its path may be collected, and when carrier 1350 moves forward, an item stored in carrier 1350 may be dispersed.

While FIG. 14A shows mechanically driven paddles, electric power may be used, such as via an electric motor and a battery coupled to carrier 1350. However, in some cases, due to the paddle wheel nature of the collection/release device 1402, battery life may be decreased since a significant amount of air may be pumped by the paddle wheel.

Referring now to FIG. 14B, an alternative paddle wheel that may be used in a carrier, such as carrier 1350, is shown. The figure shows an alternative collection and/or release device 1450. Specifically, an inner cylinder 1460 has a plurality of paddles 1462 extending radially from cylinder 1460, where the paddles may be rubber, plastic, foam, or combinations thereof. While this figure shows 10 rubber paddles, more or less may be used. For example, in one example, 2, 3, 4, 5, 6, 7, 8, 9, 11, 12, 13, 14, 15, or 16 paddles may be used, depending on the size and/or weight of the item being collected and/or dispersed, or other factors. Also, Figure shows paddle 1462 being substantially rectangular, with a tapered outer section. The paddles 1462 are also shown having raised features, such as hexagons 1464, which may be on both sides of the paddles, or only one side of the paddles. In one example, three rows of raised features may be used. The thickness of the paddles may vary, although in the example shown in FIG. 14B, the paddles are of substantially uniform thickness. Further, while FIG. 14B shows the paddles evenly spaced about the cylinder 1460, in an alternative embodiment they may be unevenly spaced.

Also, as noted above, an optional metal inertia cylinder may be used to increase the inertial of the collection device. In one example, the metal inertia may be located on cylinder 1460, which may be a hollow shaft.

Referring now to FIG. 15, a cut-away view of another example internal mechanism of carrier 1350 is shown having a collection and/or release device 1502. Specifically, an inner cylinder 1510 has a plurality of cylindrical extensions 1512 extending from said cylinder, 1512 extending radially from cylinder 1510. Cylinder 1510 may be plastic or metal, for example. While this figure shows 3 cylindrical and parallel extensions, more or less may be used. For example, in one example, 2, 4, 5, 6, 7, 8, 9, 10, 13, 14, 15, or 16 cylindrical radial extensions may be used, depending on the size and/or weight of the item being collected and/or dispersed, or on other factors. Also, while the figure shows extensions 1512 being substantially cylindrical, parallel, and circular, in an alternative example the outer radius of an extension may be varied to form various alternative shapes. Further, the radial height of the extensions may be varied. As shown in FIG. 15, the inner radial extension may be shorter than one or both of an outer radial extension. Alternatively, some of the extensions (e.g., a first extension) may be of different size (e.g., narrower, thinner, more pliable) than other extensions (e.g., a second extension). Thus, some extensions may have a first feature or shape, while other extensions have a different feature or shape.

While this example shows extensions comprising rubber, various other materials may be used in the alternative of, or in addition to, rubber. For example, plastics or metals may be used. Alternatively, foam covered plastic disks may be used to form one, or more of the extensions. In this way, less foam wear may be obtained than compared with a single cylinder of foam.

Also, in one example, additional inertia, such as in the form of a metal disk mounted to one side of the disks discussed above (e.g., so as to avoid contacting an item during collection and/or dispersion) may be used. Alternatively, additional inertia may be placed in cylinder 1510, if desired, or in any other location so as to be coupled to cylinder 1510 (for example, it may be mounted to any of the gears). In this way, rotational speed may be maintained to a better degree when encountering a vehicle to collect or disperse.

In another example, the disks used in the Cyborg City launching device may be used, including the foam disks and the metal inertia disk.

Continuing with FIG. 15, in this example (similar to FIG. 14A) mechanism 1502 may be powered by motion of carrier 1350. Specifically, either or both of wheels 1520 may be coupled to device 1502, directly or through a gear mechanism 1522, to rotate cylinder and extensions 1510 and 1512 via rotation of the wheel(s).

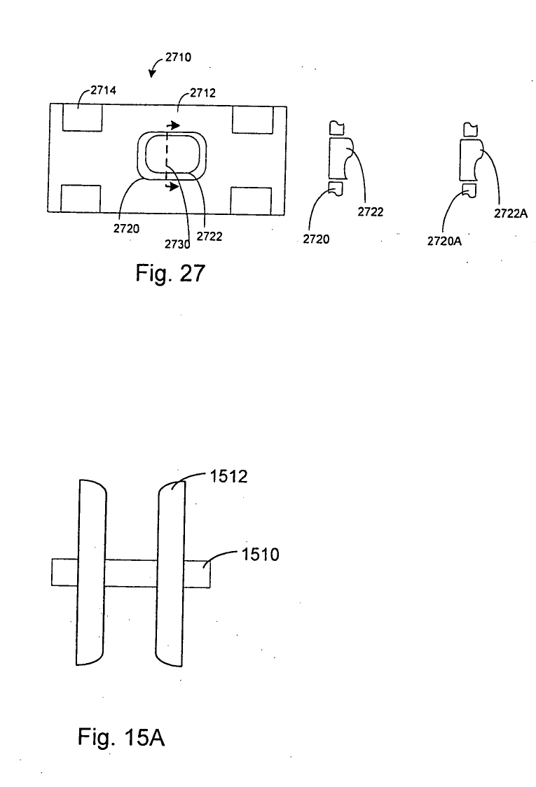

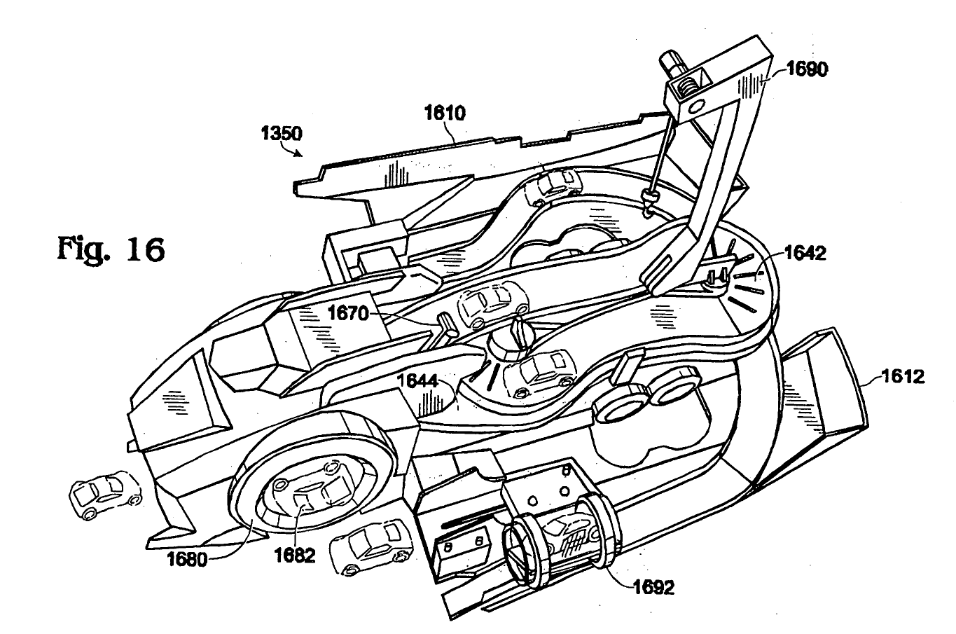

Alternatively, cylinder and extensions 1510 and 1512 may be rotated via a motor 1530, directly or through a gear mechanism 1522. The motor may be powered by a batter stored in carrier 1350, for example. The motor 1530 may be engaged by an actuation switch (see FIG. 16, for example) to rotate in a first direction to collect items, or in a second direction to expel items. The activation switch can be actuated by a user, or engaged automatically by a vehicle (such as vehicle 1352) approaching (or being approached) by carrier 1350 to cause rotation at a first speed in a direction to collect a vehicle (such as vehicle 1352) following the direction of arrows 1560 and 1562. Alternatively, an activation switch may be engaged automatically by a vehicle (such as vehicle 1540) being placed loaded into carrier 1350 to cause rotation at a second speed in a direction opposite arrow 1560. In one example, the collection speed may be slower than the dispersion speed. In this way, features of potential actuation sources (such as an electric motor) may be utilized, whereby lower speed, higher torques are available to collect items, and higher speed, lower torques are available to disperse vehicles. In this way, it may be possible to collect larger and/or heavier items, while also being able to disperse items at sufficient speed to create fin play.

Also, a separator may also be used in this embodiment similar to that described above.

In an alternative embodiment, the collection device can have an inner cylinder 1510 with a plurality of cylindrical extensions 1512 extending from said cylinder as shown in FIG. 15A. Here, the cylindrical extensions 1512 extend radially from cylinder 1510, but have a rounded outer edge, where the extension edge slopes inward toward the cylinder on the inner side of the extension. In this way, it may be able to center an incoming our outgoing item to better grip and propel the item. While FIG. 15A shows two extensions, a third, shorter extension can be added between them. The third extension can have a flat, or rounded edge, if desired. Further, more or less extensions can also be used.

Referring now to FIG. 16, addition details of an example carrier are described. Specifically, FIG. 16 shows carrier 1350 in an opened position, where the body has two hinged sections 1610 and 1612 that fold open to reveal internal tracks 1642 and/or 1642. In one example, track 1642 is the track where collected items are sent, while track 1644 is the track where items to be dispersed may be positioned. In this way, it may be possible to collect and expel different vehicle without requiring the user to physically reposition vehicles in carrier 1350. However, in an alternative example, a single internal track may be used, or more than two tracks may be used.

When in the closed position, sections 1610 and 1612 may form a handle for a user. Also, example actuation switch 1670 is shown that may be used to cause rotation of a collection/dispersion device, which may be operated when in either the open or the closed position. FIG. 16 also shows wheel 1680 which may be configured to hold a vehicle, such as vehicle 1682 via wheel clips, or magnetically, for example.

Additional features may also be added to carrier 1350, such as a vehicle crane 1690, a clear cylinder for rotating vehicles 16921, and others. For example, sounds and lights may also be added, along with additional activation switches that may be activated by a user, or automatically actuated.

As discussed above, the various disclosed items may be interrelated. For example, toy vehicles, toy tracks, codes, electronic media, games, cartoons, etc. may be theme-based, and thus, interrelated through a theme. For example, a website may be associated with one or more of the various items. The website or similar computer output may include any number of various games and/or informational pages linked with the toy vehicles, the toy tracks, etc. In some embodiments, codes, such as vehicle codes 150, may provide access to such interrelated items. Some codes may be obtained by purchasing a toy vehicle and reading the code located on the vehicle, while other codes may be obtained from web paged, cartoons, etc. The codes may provide access to one or more of the games, activities and/or informational pages, and code obtained from different sources may provide different features. For example, codes from toy vehicles may provide a first type of access (e.g., to an on-line racing game, or to a virtual world related to the car from which the code was obtained), and codes from other sources may provide a second type of access (e.g., codes from a T.V cartoon or web cartoon may provide access to higher levels, additional powers, etc.) Thus, sources of codes may comprise: products (such as toy vehicles, toy carriers, toy figures, dolls, etc.), various on-line locations, such as one or more websites of different companies (such as toy companies, cartoon companies, TV network companies, retail companies, and/or combinations thereof), newsletters, e-mail newsletters, movies, fast foot restaurant kid meals, and/or combinations thereof.

Additionally, and as described above, the codes may provide a user with access privileges to special sites, boards or levels, access to various powers or skill sets, access to previously unavailable information, access to new characters, access to historical or other factual information related to the vehicle from which the code was entered, etc.

As an example, various aspects of an exemplary website and inter-related electronic games, informational pages, activities, and other computer output are described below. It should be appreciated that such description is provided as an example and other games, informational pages and the like may be provided without departing from the scope of the disclosure.

Initially, in some embodiments a computer program may be provided. The computer program may be an online site or website. A user may be able to access the computer program via purchase, via an entrance address, such as a web address, via input of one or more codes, etc. Thus, in some embodiments, a user may reproduce the code into an electronic interface device, such as a computer or gaming device. Reproduction of the code into the computer program may result in a computer output based on the code or based on a plurality of codes. The computer output may include visual output, video clips, audio output, audio files, printouts, etc.

In some embodiments, an initializing step may be provided where the user inputs one or more codes into the program. In some embodiments, the program may request identifying data from the user after entry of the code. The identifying data may include personal identification from a user such as name, address, age, education, and other statistical personal data. The personal identification may be stored in the computer program becoming part of a database component and may be used to retrieve a prior computer output. The program may also allow a password to be created by the user where the user in subsequent games can store progress within the program.

In some embodiments, all codes may be accepted at a single entry call-out, for example, there may be universal code entry. The universal code entry may accept different types of codes, such as bonus content codes and/or game codes. In other embodiments, specific types of codes may be required for entry into certain code call-outs. For example, a game call-out may accept game codes and a bonus-content code call-out may accept bonus-content codes.

After entry of the code, the computer program may associate the entered code with a database of codes. Computer program may have a field of available codes, which may include codes that are being inputted for a first time. The availability field may identify codes which are valid and operative. The database may also contain a field of unavailable codes that are inoperative. For example, the codes may be inoperative due to prior use.

The codes may be linked with associated computer output. For example, If the computer game is a website, computer output may provide access to a different web page within the website. In some embodiments, the computer output may be associated with identifying data, such that progress of the user within the computer game may be tracked and stored. For example, these links are implemented through hypertext linking on the Internet.

An example application of the program includes various player games, such as racing games, scavenger hunts, search and find games, mazes, etc. For example, the games may be based on the concept of a scavenger hunt, where the player collects various objects or discovers objects to complete a series. Further, the games may be character-based online games, arcade-style games, race games, customizable games, on-line puzzlers or teasers, etc. The games may be single player games, multi-player games, head-on-head competition games, etc. The program may be designed to extend and enhance the appeal and value of a particular set of toy vehicles while generating ongoing excitement about the manufacturer of the toy vehicles and any line of associated goods or services. The site may provide personalized Internet game play as a bonus for each purchase of a particular toy vehicle or other interrelated item.

In some applications, a user may be able to choose or be assigned a password and choose a “personality” from a variety of fun characters. For example, a user may select a toy vehicle as their “character.” All of this user information may be stored in a user database. As noted herein, selection of personalities may be linked to codes.

In an exemplary application, a visual map of the “world” may be provided. A user may be able to see the map representing where he has been and where he needs to go on his quest. All movement within the site may be recorded in a transaction database for the user and/or manufacturer. Game play may be random for each user, thus users' experience on the site is unique unto themselves.

This theme provides a wide variety of graphical and situational opportunities. The theme may be carried through all the game pages.

To add dramatic tension, the program may include villains or the like. In some programs, a user may be able to play the game with other players logged onto the website. Each player may compete against each other or aid each other in a quest.

For example, an online game play may be provided which may be presented as an isometric racing game. For example, and not as a limitation, the racing game may enable various players to join a team which competes through various levels. The various levels may be available based on codes, timing of release or play of the game, etc. In some embodiments, it may be possible to create and develop a personalized track for game play. Such personalized tracks may be stored locally. In some embodiments, mini games or pit stops may be available to improve a vehicle's performance or to repair damage to the vehicle.

The vehicles for selection for game play may be vehicles featured in shows, such as movies, mini-episodes or products, such as toy products, etc. It may be possible to compete against other vehicles from movies, mini-episodes, toy products, etc. The various levels may correspond to environment and events presented in the shows.

Upon completion of various levels or other type of game performance and/or entry of various codes, bonus features may be available. For example, bonus features may provide availability of new tracks, competition against ghost cars, access to special powers, access to new vehicles, etc. The special powers may provide enhanced abilities to the vehicles, including steering enhancements, acceleration enhancements, brake enhancements, shooting enhancements, different weapon availability, jumping enhancements, shields, boosters, etc. Additionally, rewards may be provided for completion of various levels of game performance or for code-entry, including music tracks, videos, wallpaper, take-away posters, print-outs, etc. Various features may be available during limited runs, or at different times.

In some embodiments, two or more websites may be linked together. Codes from the vehicles may be used in one or more of the websites to link to the other websites bonus content or game play. In some embodiments, a user may be receiving the bonus content from the other website regardless of where the code was entered. Other embodiments may require specific codes to be entered in particular sites. In even other embodiments, the codes may result in different features, bonus content or game play, depending on where the code is entered into one or more sites.

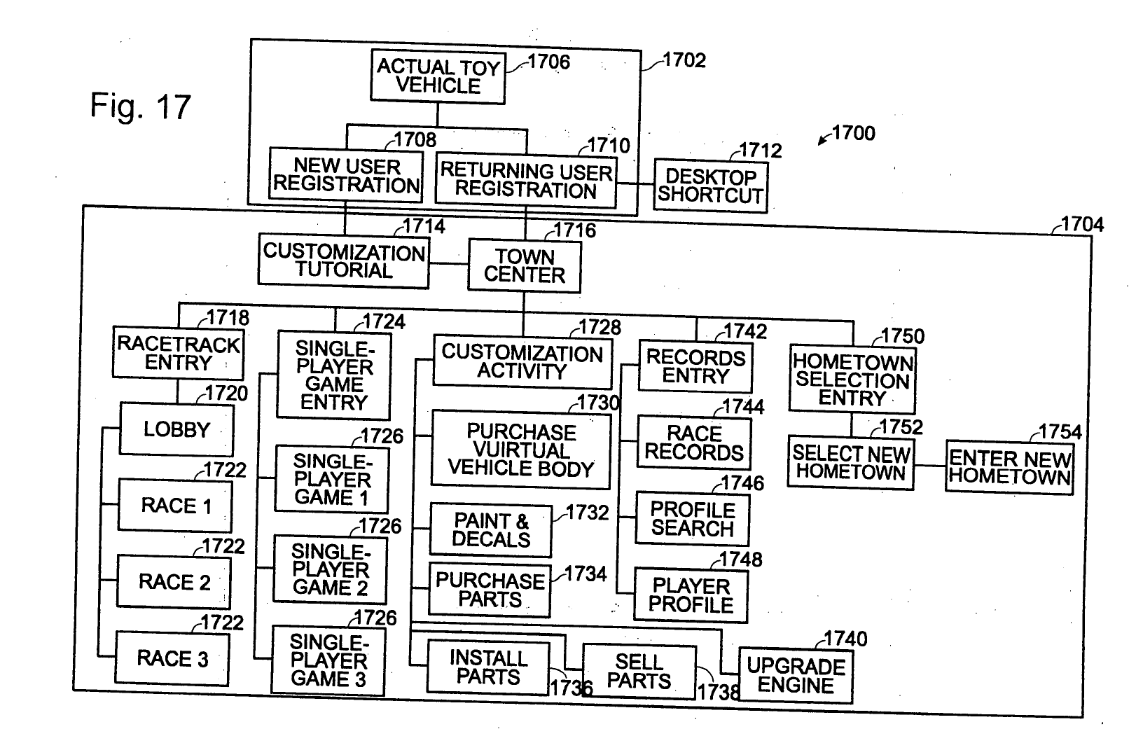

Referring now to FIG. 17, an exemplary online collection and play activity, designed such that participants may collect and customize virtual vehicles, and enter their virtual vehicles in a variety of races and other activities is described. For example, in one application, single-player activities may include arcade-style game scenarios in which a virtual vehicle may participate, and in which participants may be rewarded for their performance, and also racing games in which a participant races a virtual vehicle against a computer-controlled vehicle or against the clock. Multi-player activities may include multi-player races of various types in which a participant may enter their virtual vehicle and compete against other participants, possibly in real time through a communications network.

An exemplary system is disclosed in U.S. Pat. No. 10/361,157 to Kirby et. al, filed Oct. 22, 2003, the disclosure which is hereby incorporated for all purposes and which various parts are reproduced below.

Referring to FIG. 17, a system 1700 for playing an online game is disclosed. System 1700 preferably comprises an off-server component 1702, and a server 1704 that may be a web server. Off-server component 1702 may include an actual toy vehicle 1706, as well as a new user registration area 1708 and returning user registration area 1710. Participants may connect to server 1704 via a communications network such as the internet, although the invention may also provide a server that is connected only to a local intranet, or that resides on a single processor that is not connected to a network.

Those skilled in the relevant arts will recognize that there are many configurations through which a game with an online component may be made available to participants. For instance, registration areas 1708 and 1710 may be installed on individual processors via a CD-ROM, DVD-ROM, other software storage media, and/or via download from the internet. Alternatively, system 1700 may comprise a web server 1704 which itself includes registration areas 1708 and 1710 in an integrated fashion. Or, the entire game may be stored and/or installed on a processor via any storage medium such as a CD-ROM, DVD-ROM, or any other medium suitable for storing one or more application programs.

A user may register for the game and connect to server 1704 via either new user registration area 1708 or returning user registration area 1710. New user registration 1708 for the online game typically includes choosing a unique user name and password, whereas returning user registration 1710 typically includes entering an existing user name and password. At this point, a new user may be assigned a virtual vehicle for participation in the game, and a returning user may typically be re-associated with one or more virtual vehicles assigned and/or acquired through previous participation in the game.

Registration for the online game may be correlated to the purchase of an actual toy vehicle 1706 or by viewing another inter-related item, in which case registrations 1708 and/or 1710 may include entering a code provided in or on the packaging of toy vehicle 1706 or from the other inter-related item. Entering such a code may result in a user being assigned a virtual vehicle that represents toy vehicle 1706 in various aspects, or it may result in a user gaining new virtual parts or game credits that may be used to customize virtual vehicles, as will be described in more detail below. New user registration 1708 may also be configured to install a desktop shortcut 1712 on a computer, providing quicker access to returning user registration area 1710 when the game is played on subsequent occasions.

Considering an overview of the game elements provided by server 1704 and still referring to FIG. 17, system 1700 comprises customization tutorial 1714, and the game may be configured so that new users initially enter tutorial 1714 in order to practice customizing a virtual vehicle before entering the remainder of the online game system. From customization tutorial 1714, a user may proceed to a town center 1716, which may function as a primary hub for the logical architecture of the game. Returning users, who have presumably already passed through customization tutorial 1714 at least once, may be directed straight from registration 1710 to town center 1716, without entering tutorial 1714.

Town center 1716 may be designed as a primary central location from which many parts of the virtual game universe are directly accessible. From town center 1716, a user may navigate to racetrack entry 1718 in order to race a virtual vehicle against either a computer-generated opponent or against one or more virtual vehicles associated with other users. After passing through racetrack entry 1718, a user may navigate to virtual lobby area 1720, from which various races 1722 may be joined. Further details of these races will be discussed below.

Also from town center 1716, a user may navigate to a single-player game entry 1724, from which a plurality of single-player games 1726 may be chosen, including both vehicle racing games and non-racing, arcade-style games.

From town center 1716, a user may also navigate to a customization activity 1728. In customization activity 1728, a user may customize a virtual vehicle in exchange for virtual game credits. Specific components of customization activity 1728 include the purchase of a new virtual vehicle body 1730, the purchase and installation of paint and decals 1732, and the purchase of virtual parts 1734. In addition, a user may navigate to a parts installation area 1736, a parts sellback area 1738, and an engine upgrade area 1740. The customization features of the game will be described in greater detail below.

From town center 1716, a user may navigate to a records entry area 1742, where records related to the performance of various users and/or vehicles may be available. Area 1742 may include a race records area 1744, providing the results of multi-vehicle competitions; a profile search area 1746, from which a user may search for records related to another user; and a player profile area 1748, in which a user may update or alter their own personal player profile, which may be accessible by other users.

Also from town center 1716, a user may navigate to hometown selection entry 1750, from which they may proceed to select new hometown area 1752, and to enter new hometown area 1754. Exemplary hometown features of system 1700 will be described in more detail below.

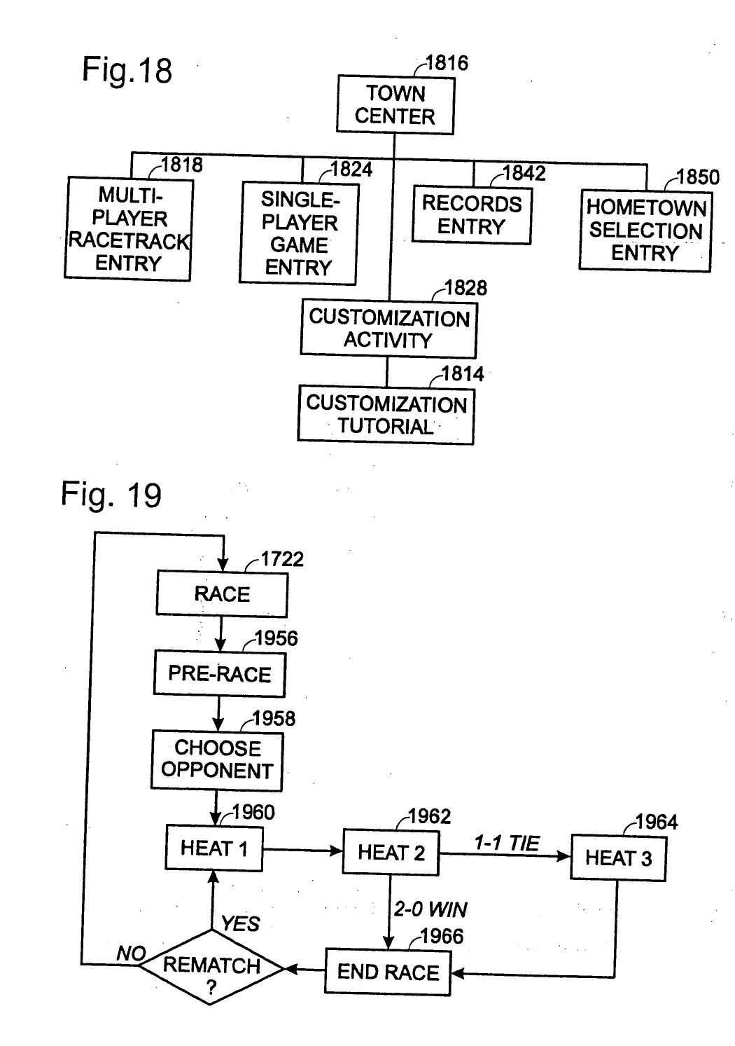

An alternate embodiment of the logical structure of town center is indicated in FIG. 18. In this embodiment, a user may navigate from town center 1816 to racetrack entry 1818, single-player game entry 1824, customization activity 1828, records entry 1842, and hometown selection entry 1850, as in FIG. 1. However, customization tutorial 1814 may be accessible from customization activity 1828, allowing a user to easily pass back and forth between customization activity 1828 and customization tutorial 1814, so that skill in customizing a virtual vehicle may be gained intermittently, while customization is underway.

An exemplary set of steps that may be part of race 1722 is shown in FIG. 19. Components of race 1722 may include a pre-race activity 1956 in which a user may become familiar with a racetrack and may be given the opportunity to activate and/or deactivate certain virtual parts for optimal performance for a particular forthcoming race. Next, a user may be directed to a choose opponent area 1958, in which characteristics of an opponent may be specified. These characteristics may include, for example, whether an opponent vehicle is human-controlled or entirely computer-controlled, an opponent's racing skill and/or experience level, and the amount of virtual credits that have been invested in an opponent's virtual vehicle.

Once pre-race activities are complete and an opponent has been selected, a race may begin with a first heat 1960, and then may proceed to a second heat 1962. In an exemplary embodiment, the race may continue to a third heat 1964 if the first two heats have resulted in a 1-1 tie, but may continue to an end race area 1966 if the first two heats have resulted in a 2-0 victory for one of the opponents. End race area 1966 may include activities such as a detailed review of the race statistics, or it may simply show a summary of the race results. A rematch option may be provided after the race ends, such that choosing to have a rematch leads to another first heat 1960, and choosing not to have a rematch leads to race area 1922, from which other aspects of the game may be accessible.

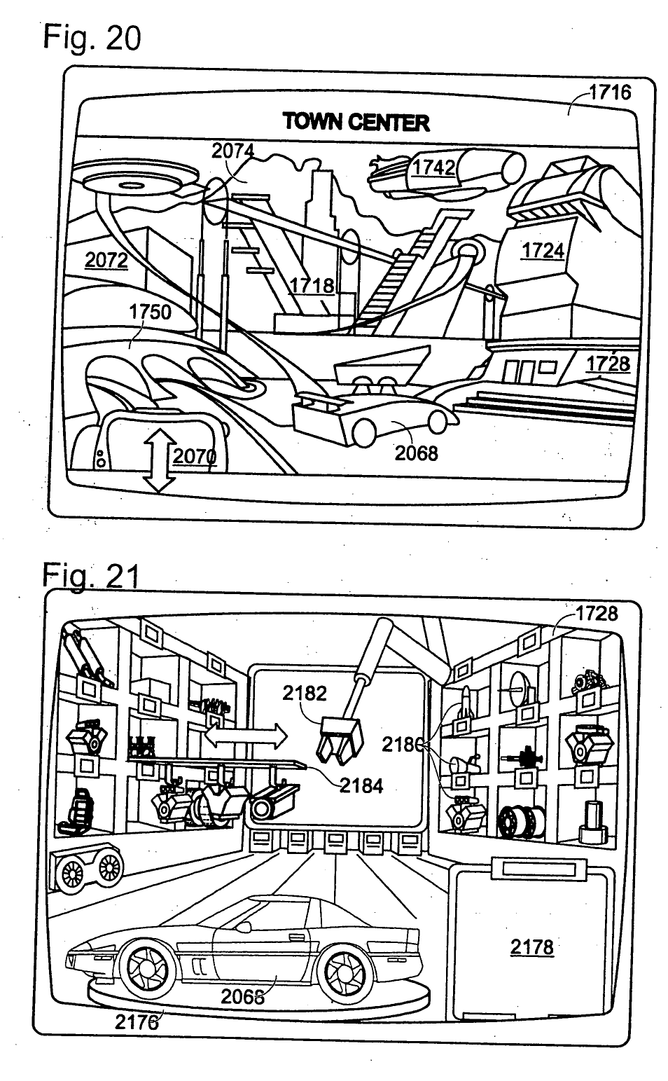

As described above, the town center may serve as a navigational hub for the online game. FIG. 20 shows an exemplary graphical representation of town center 1716 including graphical icons to represent many of the features previously described and illustrated in FIGS. 17 and 18. In FIG. 20, racetrack entry 1718 is represented by an icon resembling a racetrack, single-player game entry 1724 is represented by an icon resembling a video arcade game, customization activity 1728 is represented by an icon resembling an auto mechanic's shop, records entry 1742 is represented by an icon resembling a blimp, and hometown selection entry 1750 is represented by an icon resembling a network of roads and/or tunnels. FIG. 20 also shows a graphical representation of a virtual vehicle 2068, which may be a virtual racecar. Town center 1716 may also include a video display unit 2070, which may display information such as the current hometown and the hometown population; an ocean cube 2072, providing a link to underwater games; and a scrap yard 2074, which may be a location for the storage of damaged or destroyed vehicles and/or spare parts.

Considering in greater detail various customization features of the online game, FIGS. 21-25 show graphical representations of customization activity 1728. Note that although FIGS. 21-25 represent aspects of customization activity 1728, the features and descriptions represented therein apply equally well to customization tutorial 1714, with exceptions that will be noted below. FIG. 21 shows customization activity 1728, with virtual vehicle 2068 resting on a rotatable platform 2176. Platform 2176 is configured to rotate in response to a user command such as a mouse movement, a mouse click, or a keystroke, so that a user may examine vehicle 2068 from all angles during customization. For example, on the base of platform 2176, there may be a means, such as a graphical icon or rollover mechanism that will allow vehicle 2068 to be rotated in a full circle one time.

Also shown in FIG. 21 is a display screen 2178, which may be located in an area either behind or to the side of vehicle 2068, so that screen 2178 does not block other aspects of customization activity 1728. Screen 2178 is configured to display information about various vehicle parts, indicated at 2180. Information displayed on screen 2178 may be for a particular part, and may include a name; a price; a rarity; a power; an energy usage; and a general description, all for that part. Screen 2178 may be configured to display such information in “roll-over” fashion when the cursor is located on or near a corresponding vehicle part on the screen, in a manner familiar to those skilled in the art of web page design.

Vehicle parts 2180 may include virtual engine parts, wheels, brakes, and other conventional auto parts, as well as weapons, defensive shields, and performance enhancers of various types, some of which may have no real world analog. Parts 2180 may also include paint, decals, and other components designed to augment the appearance and/or performance of vehicle 2068. Once selected, various parts may be installed in or on a virtual vehicle using robotic arm 2182, which is configured to hold one of parts 2180 in its robotic jaws and then to install that part into a virtual vehicle. Upon selection of a type of part, preferably by clicking on a corresponding icon with a mouse, a sliding shelf 2184 will appear, holding specific and selectable individual parts. Selecting a specific part from shelf 2184 results in the part being picked from the shelf by robotic arm 2182, in preparation for installation into vehicle 2168.

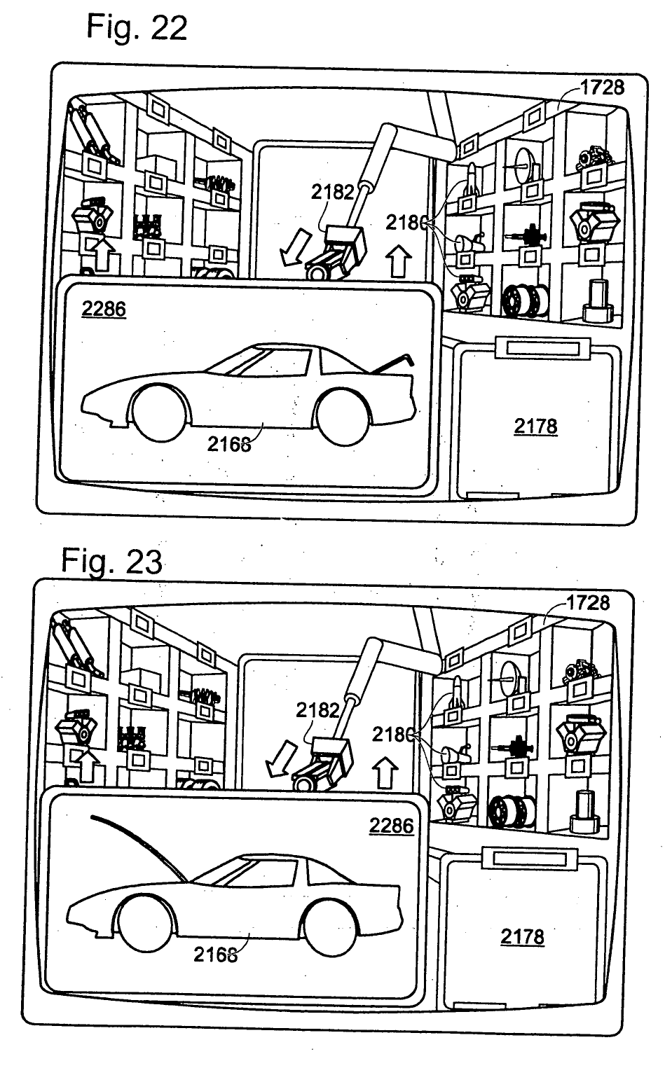

FIGS. 22 and 23 show alternate views of customization activity 1728 during the installation of one of parts 2180, including also inventory display 2286. Inventory display 2286 may be configured to remain out of sight unless activated by a user command or a cursor movement, for example a motion of the mouse pointer over virtual vehicle 2068. Once activated, display 2286 may slide upwards or otherwise appear, until it may completely intervene between a user's line of sight and vehicle 2068. At this point, display 2286 may be configured to display an x-ray or other semi-transparent view of vehicle 2068, as is best seen in FIGS. 22 and 23.

If a specific vehicle part 2180 has been selected, it may have been automatically procured by robotic arm 2182, as described previously. In that event, clicking on a particular area of the semi-transparent representation of vehicle 2068, such as on the hood portion, will cause the selected part to be installed in the vehicle. Clicking on another area of the semi-transparent representation of vehicle 2068, such as on the trunk portion, will cause the selected part to be stored in the vehicle for possible future use.

In either case (installation or storage), the price of the part may be subtracted from the user's total amount of virtual game credits. If the user is merely practicing vehicle customization through the use of customization tutorial 1714, then the purchased part may be removed and the virtual game credits will be restored to the user's account at the end of each operation, upon leaving tutorial 1714, or at another suitable time, so that the customization will be substantially reversible. However, if the user is customizing a virtual vehicle in customization activity 1728, then the credits may not be restored and the customization may be substantially irreversible.

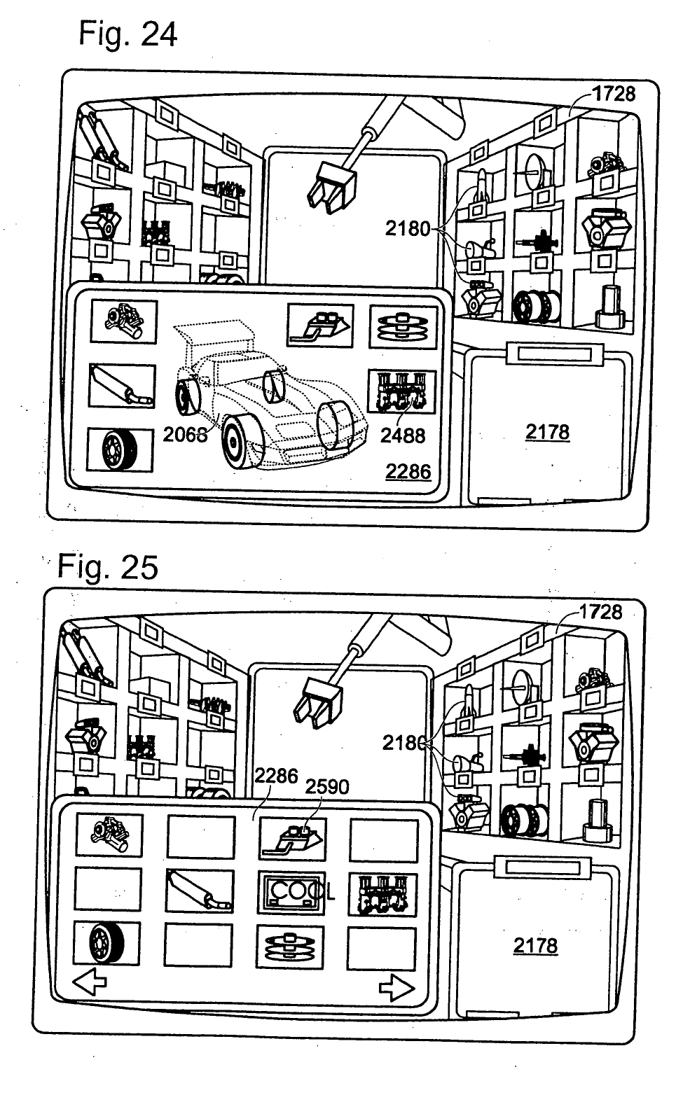

On the other hand, if a specific vehicle part 2180 has not been selected when inventory display 2286 is activated, then clicking on a particular area of the semi-transparent representation of vehicle 2068, such as the hood portion, will cause an inventory of previously installed parts 2488 to be displayed on inventory display 2286, as is indicated in FIG. 24. Similarly, clicking on another area of the semi-transparent representation of vehicle 2068, such as on the trunk portion, may cause an inventory of purchased and stored parts 2590 to be displayed on inventory display 2286, as is indicated in FIG. 25.

Addressing more particularly the subject of virtual game credits, upon first entering system 1700, or a specific portion thereof such as customization activity 1728 and/or customization tutorial 1714, a user may receive an initial amount of virtual game credits. These game credits are provided for the purpose of customizing and/or upgrading virtual vehicles, and possibly for purchasing new virtual vehicles and parts. In customization activity 1728, parts and/or other customization features are obtained by a user in return for a reduction in the amount of virtual game credits, and this reduction and the corresponding modifications made to a virtual vehicle are substantially irreversible. In tutorial 1714, however, any reduction in the amount of virtual game credits provided will be reversed before a user leaves the tutorial, since a purpose of the tutorial is to allow reversible customization of a virtual vehicle for practice purposes. In this way, a user may determine how to add paint, stickers, decals, car parts, weapons and other components to a virtual vehicle using trial-and-error, in a substantially reversible way. Also, a user may determine exactly which combination of these various components they prefer to spend their virtual game credits on, as the amount initially provided is limited.

Increases in a user's amount of virtual game credits may occur as a result of being declared a winner in a competition such as a multi-player race, and for participation and/or performance in various single-player activities. The amount of virtual game credits available to a user will determine their ability to further customize their virtual vehicles, to purchase and customize new virtual vehicles, and thus to advance in skill and experience within the virtual online game provided by system 1700.

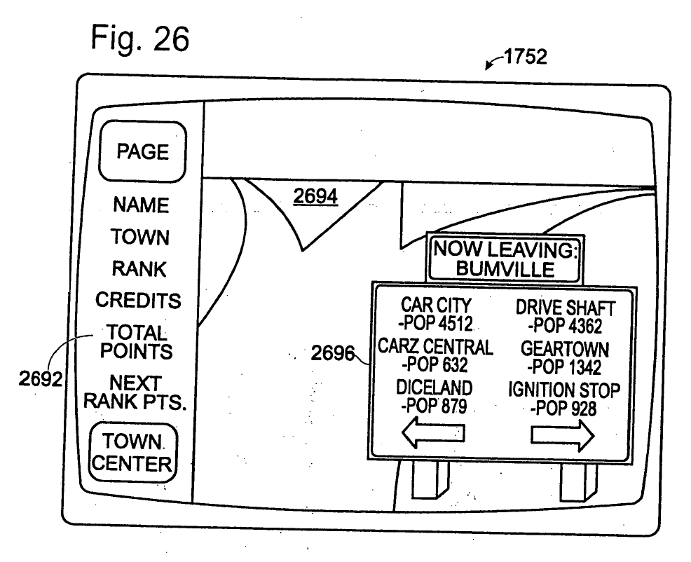

Considering now more details regarding hometown selection entry area 1750, recall that this area leads to hometown selection area 1752 and new hometown entry area 1754. A graphical representation of an embodiment of hometown selection area 1752 is shown in FIG. 26. This selection area may include a display 2692 showing various information about a user such as a user name, current hometown, player rank, available game credits, and so forth, as well as a link back to town center 1716 and/or other areas of system 1700. This information may be similar or identical in content to information available in player profile area 1748, which is reached through record entry area 1742. In addition, hometown selection area 1752 may include a graphical representation of a fork 2694 in a road, or other similar dividing point, indicating that choices are available as to a next hometown destination.

Selection of a new hometown may result simply from clicking on a branch of fork 2694, or the various branches of fork 2694 may be labeled with names or icons representing other hometowns (not indicated in the figures). For example, a hometown selection window 2696 or other similar means is provided, possibly associated with a “roll-over” feature, to facilitate selection of a new hometown. The selection of a hometown may augment participation in the online game as follows. In some embodiments, a user may compete in races against other users associated with the same hometown, and receive an individual performance ranking within their hometown as a result of the outcomes of these competitions. On the other hand, members of a given hometown may challenge members of another hometown to competitive races, the outcomes of which may be used to determine a hometown performance ranking relative to other hometowns. In this manner, competition, teamwork and loyalty are all evoked within the context of an online game experience.

As described above, codes may be used to enhance the play appeal of the games. As described above, the codes may be provided on vehicle cars or other inter-related items, including cartoons, books, movies, etc. Moreover, it should be appreciated that although the disclosure describes vehicle-related games and toys, the games, the codes, etc. may be applied to, or be based, on other types of toys, including vehicles, dolls, etc.

Multiple features of interrelated items are described above. Each of the above items may be provided as stand-alone methods, systems and/or devices. In some embodiments, one or more of the methods, systems and/or device may be included within a theme-based game set. The disclosed theme-based game set is provided for illustrative purposes and is not intended as a limitation.

In an exemplary theme-based game set, a plurality of vehicles are provided. The vehicles may be configured and grouped such that multiple vehicles belong to the same team or group. The vehicles may include marking indicia identifying the vehicles as part of the team or group. For example, in some embodiments, the vehicles may include translucent or transparent colored wheels which, in addition to the above described functions, may identify a team or group of vehicles.

In some embodiments, the vehicle may be configured to enhance the play experience. For example, the vehicle may have features that improve track performance of the vehicle, including a low center of gravity, specially configured low profile wheels, co-molded wheels, etc. Further, additional features may be provided which increase playability and/or collectability of the cars, including high paint quality, low profile wheels, translucent and/or transparent wheels, etc.

Further, in some embodiments, the vehicles may include codes which may be linked to inter-related items, including, but not limited to toys, toy vehicles, track sets, electronic games, interactive websites, cartoons, card games, magazines, books, puzzles, etc. In some embodiments, the codes may be laser-etched or otherwise applied to the vehicle body.

The codes may provide access to features within the inter-related items, such as access to games within a website or special information regarding the cars. Similarly, any one of the interrelated items may further provide codes for use to provide access to such features. For example, codes may be provided within an inter-related cartoon or on track sections.

As discussed above, in some embodiments, the vehicles may be packaged with an inter-related item, such as a card or plurality of cards. The cards may be collectible cards or game cards. The package and/or the vehicle within the package may partially obscure the content of the cards.

In some embodiments, additional toys may be provided which may be used with the vehicles described above. For example, a carrier vehicle may be provided which is configured to collect a vehicle or other toy from a first direction and disperse the toy in a second direction. Other interactive toys may also be provided.

Referring now to FIG. 27, an improved method of displaying a logo on a product, such as a toy vehicle, is described. Specifically, a “pop-through” appearance may be used to highlight information (such as a product's logo, or other text or designs) so that the attention of a purchaser or user is directed to the information. For example, a cut-out logo display may be provided on a toy or other object.

For example, a protrusion may be provided on a toy which may be configured to at least partially extend into a frame of the toy. The frame may include an opening to receive a portion of the protrusion. By partially extending into the frame, the protrusion may appear to pop-through the frame. The protrusion may be shaped as a logo. As used herein, logo may include any name, indicia, marking, etc. For example, the logo may be used to identify the product or the product manufacturer. In some embodiments, the logo may be a trademark.

Specifically, in this example, a bottom view of a toy vehicle 2710 is shown, which may be any of the vehicles described herein, or another type of vehicle. In this example, vehicle 2710 has four wheels 2714 and a bottom plate 2712. Bottom plate 2712 may be part of a chassis or other undercarriage of the vehicle. Further, a hole or opening 2720 (which may be considered to define a frame) may be provided in bottom plate 2712. A logo section 2722 may extend though opening 2720. This is illustrated further in a cross-sectional view along line 2730.

Logo section or logo 2722 may be an extension from the body. For example, in some embodiments, logo section 2722 may extend from the interior body section of the body. For example, in some embodiments, the logo section may be molded with the body.

In one example, bottom plate 2712 is substantially flush with logo section 2722 as shown by the cross-sectional view. In another example, bottom plate 2712A may not be substantially flush with logo section 2722A as shown by the alternative cross-sectional view. Thus, without departing from the scope of the disclosure, the logo section may be substantially coplanar with the surface of the frame, may be below the surface of the frame, or may extend above the surface of the frame.

As shown in FIG. 27, the shape of the opening is substantially related to the shape of the logo section 2722, and encircles the logo section. For example, the opening may substantially correspond to the shape of the log section. However, in an alternative embodiment, the shape of the logo section may be dissimilar to the shape of the opening, even though the opening may still encircle the logo section. In still another alternative embodiment, the opening may only partially encircle the logo section.

In one example, logo section 2722 includes a raised logo on logo section 2722 (not shown), although it may be flat writing or a flat design.

In one example, logo section 2722 and bottom plate 2720 may be formed in separate pieces, although in an alternative embodiment they may be formed of a single piece, or from separate pieces coupled together. In one example, the coloring of logo section 2722 and bottom plate 2720 may be different so that the logo is more easily seen. Further, logo section 2722 and bottom plate 2720 may be formed of dissimilar materials to further highlight the logo. Also note that many different logos may be used, and the approach described herein is not limited to any one specific logo. Further, one pop-through logo may be used, or several may be used on a product. Further still, the logo may be in various locations, including the top, side, or other location of the product.

The combination of a frame and a protrusion as integrated into the toy may operate to make the logo on the toy more conspicuous to a viewer. Additionally, by using different materials between the frame and the protrusion and/or using different colors for the frame and the protrusion, the logo may be more prominent. The contrast between the frame and the protrusion by using the cut-out logo display described above may serve to highlight the logo (or other select indicia) and direct the viewer's attention to such markings.

By integrating the logo into the toy, such as the toy vehicle example described above, the logo may be more resilient to alteration. Moreover, the logo may be more wear resistant, such that over time and use of the toy, the logo may remain visible to a viewer.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of manufacturing a toy, comprising:
forming a human readable code on a section of the toy by laser etching material from said section.

2. The method of claim 1 wherein said code comprises six digits.

3. The method of claim 2 wherein said toy is a vehicle.

4. A system comprising the toy of claim 1, and further comprising an electronic interactive media configured to receive said code.

5. A method of manufacturing toys, comprising:
forming a first human readable code on a section of a first toy by laser etching material with a device from said section; and
forming a second human readable code on a section of a second toy by laser etching material with said device from said section, said first code different from said second code.

6. The method of claim 5 wherein said first human readable code is located on an underside of a first toy vehicle, and said second human readable code is located on an underside of a second toy vehicle.

7. A product, comprising:
a collectible toy vehicle having a body and chassis, said chassis having a human readable code imprinted thereon formed by laser etching material from said chassis; and
a computer program configured to be operated on a computer, and configured to receive said code, where said program produces a computer output based on the code entered, wherein said output includes content dependent upon the code entered.

8. The product of claim 7 wherein said content comprises personalized game play.

9. The product of claim 8 wherein said personalized game play includes a game having features customized to a user.

10. The product of claim 7 wherein said content comprises access to a game feature.

11. The product of claim 7 wherein said content comprises access privileges to specialized web pages.

12. The product of claim 7 wherein said content comprises increased access privileges to different levels.

13. The product of claim 7 wherein said content comprises extra power.

14. The product of claim 7 wherein said program is further configured to create a customized feel for each user.

15. The product of claim 7 wherein said computer program is configured to be operated on a networked computer.

16. The product of claim 7 wherein said computer program is further configured to be operated on a website.

17. The product of claim 8 wherein said personalized game play includes a game-play personality.

18. The product of claim 8 wherein said personalized game play includes where the user takes on a role.

19. The product of claim 8 wherein said personalized game play includes navigation within the program.

20. The product of claim 8 wherein said personalized game play includes racing.

21. Packaging comprising the product of claim 7, and further comprising a card for use in a card game.

22. A coding system comprising:
a plurality of toy vehicles, each toy vehicle having a vehicle code; and
a database including a plurality of codes, wherein the codes are associated with a computer output and wherein entry of the vehicle code in a device linked to the database results in a computer output specific to the code.

23. The coding system of claim 22, wherein the vehicle code is a bonus content code.

24. The coding system of claim 22, wherein the vehicle code is a game code.

25. The coding system of claim 22, wherein the computer output is related to the toy vehicle having the vehicle code.

26. The coding system of claim 22, wherein the computer output is a computer game.

27. The coding system of claim 22, wherein the computer output is a web page.
